(19) United States
(12) Patent Application Publication
(10) Pub. No.: US 2004/0242405 A1
(43) Pub. Date: Dec. 2, 2004

(54) Construction methods in space

(76) Inventor: Gregory Michael Orme, La Vergne, TN (US)

Correspondence Address: Greg Orme, 310 Oakwood Love, La Vergne, TN, 37086-4130, US

(21) Appl. No.: 10/489,638

(22) PCT Filed: Sep. 18, 2002
(86) PCT No.: PCT/AU02/01274

(30) Foreign Application Priority Data
Sep. 20, 2001 (AU) PR 7793
Oct. 29, 2001 (AU) PR 8533
Nov. 19, 2001 (AU) PR 8956
Dec. 12, 2001 (AU) PR 9447
Jan. 10, 2002 (AU) PR 9903
Mar. 18, 2002 (AU) PS 1000
Mar. 18, 2002 (AU) PS 1150
May 7, 2002 (AU) PS2172
Aug. 27, 2002 (AU) 2002951004

(51) Int. Cl. H01M 4/88

(52) U.S. Cl. 502/101

(57) ABSTRACT

A scooping means to collect gases and materials from the atmosphere and to compress them into liquids and solids. Preferably the scooping means is a space craft and the gases and other materials are in the upper parts of the atmosphere; the materials could be processed into slabs for construction or are broken down to be reprocessed into other chemical structures.

### FIELD OF THE INVENTION

The present invention relates to the construction of objects in space.

### BACKGROUND OF THE INVENTION

Constructions in space are very expensive because each kilogram of material must be brought from the surface. Until now there has been no alternative to this expense, which has made space exploration take so long to progress. Many people thought we would have colonised other planets even by now after seeing the Apollo missions in the 1960's.

One major problem is radiation exposure in space which requires large amounts of heavy matter as shielding. In fact most problems associated with space travel would be solved if we could have enough raw materials in orbit. In many cases they need not be sophisticated technology, but raw materials from construction that we take for granted on the surface.

### SUMMARY OF THE INVENTION

One fundamental problem in space exploration and colonisation is the expense in getting materials up into orbit. This expense will eventually be overcome by for example mining and constructing on the Moon or asteroids but until now there has been little alternative but to continue from Earth.

The present invention gives a way to overcome this barrier and shows there are fact abundant materials for building with closer to Earth Orbit.

Essentially this is done by collecting gases, dust, and materials from the upper parts of Earth's atmosphere, compressing them preferably into solid blocks and using them to build with. For this purpose there is an all but unlimited amount of material available, and there is no need to go to the expense of bringing it up from the surface.

### BRIEF DESCRIPTION OF THE DRAWINGS

FIG. 1 shows a groove in a material to be used as a light conduit.

FIG. 2 shows these grooves in two sections to be assembled together to make a conduit.

FIG. 3 shows other sections to be assembled into different shaped conduits.

FIG. 4 shows light conduits substantially parallel to each other with facets to direct light in various directions.

FIG. 5 shows a light collector to be joined with other similar arrays by optic fibres to direct light to a common area.

FIG. 6 shows wearable glasses with facets angled so as to give a view of a display screen while also giving a frontal view.

FIG. 7 shows an interference assembly to boost an electromagnetic or any wave like signal.

FIG. 8 shows a means to convert an electrical signal into an optical one, and to direct it onto a display.

FIG. 9 shows a display means that directs light according to variations in a magnetic field through an aperture to a display.

FIG. 10 shows a receptor that can determine the frequency and intensity of a light beam.

FIG. 11 shows a series of linked gyroscopes to resist reorientation and a gearing means to turn it.

FIG. 12 shows a computer device such as a mobile phone or PDA with a projection and camera means on a stand.

FIG. 13 shows a representation of a keyboard as an image, with a pointing instrument.

FIG. 14 shows an LCD and a CCD camera means to project an image and to receive changes in that image from user inputs.

FIG. 15 shows an LCD and CCD array using a one way mirror.

FIG. 16 shows an array of LCD and CCD pixels.

FIG. 17 shows an LCD and CCD array with a focussing means.

FIG. 18 shows two arrays with a focussing means between them.

FIG. 19 shows a cooling means with a rotating section on a computer chip.

FIG. 20 shows vanes inside the rotating section of the cooling fan.

FIG. 21 shows cooling fins and an additional fan above the rotating section of the cooling means.

FIG. 22 shows vanes moving fluids away from hotter parts of the electronic chip.

FIG. 23 shows a bar that can move backward and forward or rotate away from the hotter parts of the CPU.

### DETAILED DESCRIPTION OF THE DRAWINGS

According to one aspect of the invention there is a means to collect gases, a means to pressurise those gases preferably into a liquid or solid, and a means to output those materials for further processing.

It is preferred these collection means are space craft that are at times outside the Earth's atmosphere.

These spacecraft would have an ability to fly in and out of the atmosphere, with a protective means to prevent them from being burnt up by their re entry speed.

Preferably they would have a propulsion means based on nuclear energy, ion propulsion or the burning of hydrogen though any means can be used.

Inside the craft would be a scoop to collect gases as it was moving at speed descending into the atmosphere. These gases would be directed to a compression means which would convert them to a liquid or solid and store them inside the craft.

Preferably the craft would be very large and be designed to rarely land on Earth though landing may be desirable in some variations. For example it may refuel itself in space to land on Earth.

As a preferred embodiment the craft starts its run in orbit outside the atmosphere possibly near other craft such as a space station. In an embodiment it would be powered by containing hydrogen and oxygen for burning, or a nuclear reactor could assist in expelling heated gases at high velocity.

Next the craft begins a preferably shallow descent into the atmosphere so it can either by its momentum or an additional thrust regain orbit. A shallow descent should give a desirably low friction and heating to the craft to prevent damage.

At this high speed air is scooped into the craft similar to on a ramjet, which under the pressure of its speed and by compressors the air is cooled and liquefied or frozen.

The objective then is to collect large amounts of air and other materials such as dust and take it to orbit. As the craft regains orbit it may continue to freeze the gases or it may dock with other craft to assist in this.

The air itself then becomes a raw material to build with. Water and Carbon Dioxide contain Carbon, Hydrogen and Oxygen which can be used to form carbohydrates and hydrocarbons.

Preferably forms of plastic can be manufactured to build more objects with. There are also of course many uses for carbon in construction as well.

Also sheets of frozen air can be used as panels to build with.

Preferably these panels can be moulded by freezing the gases in the required shape. These can then be covered from sunlight and maintained as a solid or liquid. In some variations hydrocarbons and other solids can be made to encase these gases.

These can then stop radiation and be formed as a shell for example where buildings can be made inside. Nitrogen can be used to synthesise fertilizer, there is water, and of course oxygen.

In short then these materials can potentially be used to construct all aspects of space craft, habitats, and any other object as desired. Of course this can equally be used anywhere, even on Earth. It may be desirable to collect materials this way for example in construction of objects here, even to for example make plastics where there are no raw materials but sufficient energy.

According to another invention there is provided a means for creating a focusing reflective surface.

This relates to the field of telescope construction.

Preferably the surface is formed by a liquid that may in some embodiments dry to a shiny surface and in others such as using Mercury remain a liquid. In some embodiments small icons in various shapes including small reflectors are used in place of the liquid. For example these might be small circular or other shaped, substantially flat mirrors.

Preferably this surface uses gravity or acceleration and spinning to create its shape. On earth gravity would be used and in space an acceleration or deceleration mimics the gravity.

Preferably the shape is retained by while the surface transforms by hardening, freezing, curing, or other means to change into a solid surface.

In the preferred embodiment a reflective material such as certain plastics is placed into a receptacle in a molten state. This receptacle can be spun so that the surface of the material forms a parabola which is ideal for use in a telescope. The receptacle may itself be parabolic in shape so the material forms a thin layer, which minimises the amount of material needed. As the material dries it forms a mirror which can be suitable for focusing in such applications as astronomy. If Mercury is used it may remain a liquid in which case the spinning and acceleration would continue while it is being used.

According to another aspect of the invention the material used is preferably Mercury over which a transparent molten material is placed. As the device is spun there forms layers with a bottom one of Mercury or some other reflective material and a top layer of glass, plastic or another transparent material.

As the transparent material cools it may solidify into a parabolic shape that with its weight forces the mercury underneath to remain in a parabolic shape without spinning, by the weight and rigidity of the material on top. Since the transparent material lets light through and can preferably be used as a lens, the reflective means can work as a parabolic telescope or camera.

It also, in the case of a hardening surface, has the advantage of not needing to be spun constantly to retain the parabolic shape.

According to another aspect of this invention a mirror can also be made in space this way. A parabolic shaped or other receptacle is launched with a material to be spread over its surface. This may be mercury or a molten material to set, but is preferably highly reflective. The craft is accelerated or decelerated to mimic gravity and the receptacle is spun so the material forms a parabolic shape. A receiving means such as CCD's preferably similar to those used on the Hubble Space Telescope are placed at the focal point.

Essentially this is like the parabolic mirror on Earth except that acceleration is used in place of gravity. If the material remains liquid the craft can continue to spin and accelerate perhaps gently by such means as an ion drive.

When the craft turns or needs to alter course to point at a new target the surface, if still liquid may be disturbed but it will resume its shape in time. Baffles may be placed in the liquid to reduce waves in it. Of course if solid it will retain its shape.

The focusing of all these mirrors may sometimes need to be adjusted by adaptive optics, where normally the mirror is distorted in shape to compensate for atmospheric disturbance. For example it may be pointed at the Earth.

In this preferred embodiment adaptive optics are done by placing magnets or electromagnets near preferred points under the mirror. A magnetic or electric field causes light to bounce off the mirror at a different angle, and so this can be used instead of actually distorting the mirror. Of course it may also be desirable to distort the surface in some embodiments.

According to another invention there is a means to route light and other frequencies through channels so as to give an illusion of reduced visibility and detect ability by various sensors such as cameras, eyes, and radar. Routing these signals can also be used in display means, circuitry and all other known applications suitable for transmission of signals.

In fact all of the inventions in this application have separate parts to them, and each part should be considered to be not limited in any way by the context it appears in, but they can be considered as separate inventions with all the applications those skilled in the art can use them for. Of course this applies to the complete inventions as well.

Prior patent applications WO9910766, WO0131384, and WO02054378 and their associated priority documents disclosed many applications and embodiments for the use of these signal channels in displays and circuitry as well as other applications.

Preferably they use a mobile assembly to be placed around a vehicle or person, or around a stationary object. For example there may be a suit like a cloaking device that would work in a similar way to that used in the first Harry potter film to look invisible. Other applications would include a cladding or covering to hide vehicles and buildings.

Preferably they use optic fibres and channels connected to an outer layer of lenses and light focusing means to direct electromagnetic radiation falling on the object to its other side, in approximately the same line of site as to which the beam would have taken if the object were not there. This gives the illusion of invisibility as described in the prior art of my patent applications disclosed earlier.

In an embodiment the surface of the invisibility device can have small magnets to attenuate other radiation falling on it, in effect to reduce radar reflection.

In a preferred embodiment the main problem involved in the construction of such devices is their complexity, in that many connections have to be made from one side of an object to the other side to give the illusion of invisibility. To give an example of this complexity consider a rectangle 1 meter cubed that is to be made invisible by placing 1 square centimetre square lenses all over its surface. As each side would have 10,000 lenses and there are 6 sides then there would be 60,000 lenses. If each lens had for example 10 sockets connecting to optic fibres then there would be 600,000 connections to be made in an area which is very small. This would be about the surface area of a cloaking device for a man to wear.

Ideally this embodiment of a wearable invisibility cloak would be not too heavy, using lenses and optic fibres as well as the channels described herein. It would have small openings for the eyes or there may be sections to divert some light from lenses into a viewing screen.

The solution to this is to create at least one patch panel in which various optic fibres or conduits converge and connect to with a socket. In the case of the example described one patch panel would have 600,000 connected optic fibres and channels of all kinds known in the optical industry. Clearly this possible to make but time consuming and expensive.

Next there is a device for the transferral of electromagnetic radiation from one optical input to another with the observation that in this example these connections are two way. Light as the preferred medium can pass both ways through the fibre each without interfering with the other's signal.

In other preferred applications these connections can be employed in such areas as optical switching and routing and communication networks of optic fibres. In this example this invention is employed to promote invisibility while all other application in these areas are also assumed to be referred to as well. In fact these optical conduits would have as many applications as optic fibres are used in.

This preferred device instead of relying solely on connecting optic fibres to each other, like in a patch panel of network cables for example, also uses materials that have hollow channels in them. These channels preferably have a reflective means on their inner surface so that instead of light moving down an optic fibre by internal reflection the light moves down these channels by reflecting off the surface of the channels as shown in FIG. 1.

Here a preferred medium of light A goes through a pipe like conduit through the object B, which can be of any shape and size, and of course the conduit can be of varied shapes as internal reflection will normally make sure the beam comes through to the other side.

The preferred solution here is in FIG. 2 where B is shown in 2 halves with a groove with a preferably semi circular cross section on each section. In some cases it may be desirable to make this groove of varying depths and of different cross section shapes, to make it easier to manufacture, to avoid the groove narrowing when B is bent, and to permit the inclusion of various icons and devices in the grooves.

Preferably these grooves can contain air or certain desirable gases which could conduct electricity and filter if desirable some frequencies, but they could also use a vacuum or a transparent medium such as glass or plastic which is manufactured to sit in the grooves. Preferably the medium to be transmitted is light but also fluids, particles such as objects and even electrons can be directed through. For example electrons may be transmitted in a vacuum down these channels in circuitry and to a display means from an emitter such as used in a cathode ray tube, as well as other applications.

In these channels there may be certain objects as icons. Preferably these icons can be mirrors, lenses, means to alter the polarization of light such as from horizontal to vertical or to circular polarization.

Preferably these icons can be employed as shutters to regulate the flow of electromagnetic radiation, even electrons such as in optical logical circuitry, by stopping the beam or to reduce or magnify it.

Preferably the grooves can be braced to be more rigid, to resist crumpling more, or they can be made weaker in places to allow outside pressure and other input to reduce the cross section of the grooves.

In another preferred aspect the grooves can cross over each other and intersect at varying angles. Preferably these angles would be 90 degrees so that light from one groove would be less likely to leak into the other, unless this is a desired operation. This relates to another aspect disclosed in my application WO013184, FIGS. 1 to 5 therein where crossing over of channels are shown as optical fibre and similar conduits and also as hollow channels as described here. More examples of this are outlined in my PCT WO9910766.

As can be seen then these grooves can mimic all of the possible conduit possibilities of optic fibre and indeed even electrical circuitry if they contain a conductive substance. For in FIG. 2, B may itself be a conductive material in which case it would be in sections separated from each other by electrical icons such as resistors, transistors, capacitors, and so on.

In a preferred aspect of this the grooves may have a coating that is electrically conductive to act like wires or resistors, even capacitors.

In effect then all kinds of networkable communications and circuitry can be made by these grooves in material, and when the pieces are put together one has these pipes going through the material B in FIG. 2.

In an embodiment relating to invisibility one could make grooves all over a surface as described leading from each optical connection to the one that carried light to the opposite side of the object to be made to appear invisible and so create a patch panel of grooves. This is much easier to build because these grooves can be made by many known manufacturing techniques.

Preferably these methods would include moulding the grooves, cutting them with lasers, stamping them on a press, etching them with corrosive agents and all other known methods by one skilled in the art. Normally such constructions would not contain an inventive step as making marks like these is common in many industries. For example moulding or stamping these would be very similar to known industrial processes.

Preferably the material used would be soft enough to stamp in this embodiment, which could be material such as paper and cardboard, shiny plastic, aluminium foil and all other materials.

While the examples shown so far would be 2D the method easily extends to a 3 dimensional assembly of layers and sections.

In FIG. 3 there are 2 layers. The first layer shown has holes which represents these grooves as holes going at various angles preferably vertical here. The second layer shows a groove that may preferably be horizontal here but may also be at an angle. The section at E may be rounded into a predetermined shape so light is turned upwards by reflection. One could imagine any form of pipe connections being formed in these ways in layers to move light through the assembly. In this way outside connections to optical and electrical circuitry such as in the invisibility example can be made on each surface. Also the sides of the channels can be electrically conductive to combine an electrical circuit with an optical one

By manufacturing the layers one can then assemble them into a 3 dimensional conduit of light and other media such as fluids, particles and so on. At various points one can manipulate this flow as said before as desired.

The advantage then is that in this example 100 layers could have grooves and holes as described, and be coated with a suitable reflective material and transmit these 600,000 signals as well as by constructing 600,000 optical connections. Indeed it can be seen how this can speed up the assembly of optical computers, routers, and all other kinds of optical and electrical circuitry. One preferred embodiment would be a circuit board that contained electrical components and also optical ones integrated together.

Another embodiment of this concept would be to create display devices and cameras. In this example instead of using the grooves as just conduits for digital and analogue signals, these signals can go onto a display surface connected to the assembly that can transmit this signal.

Preferably this emission would be for a display looking like a TV, monitor or something similar, but can also project other radiation and output particles and liquids as before.

In a preferred example one can construct an assembly of grooves as described earlier so that at least one face has a conveniently viewable surface. While this surface can be any shape, irregular or periodic to reduce moire patterns, here it is flat and the display is 2 or 3D.

The surface can also be of any shape disclosed in my previous patent applications disclosed earlier. On the surface of this screen can be emitting icons such as phosphor and other fluorescing materials known to the art.

Electric current or electrons can flow preferably through a vacuum in some of the channels, and lenses and mirrors can be used in the grooves to create an image and other effects.

An array of lenses and tubes was disclosed in patent application WO09910766 to direct light in various directions.

In an embodiment tubes of transparent material such as optic fibres can be placed on the surface of the display means to receive light from the grooves, or from any other light emission. For example these could equally be used on a plasma display, an LCD, or a Cathode ray tube. These are shown in FIG. 4. Materials containing parallel optic fibres like this bound together are well known in the art. They have the effect of making light entering them travel in each fibre parallel to the other rays of light. A represents the tubes and B to send a signal into them.

Preferably each tube is cut in a flat, concave, convex or other shaped face at the end, at an angle C so light is refracted or reflected of it in a preferred direction. For example if the end of the optic fibre or conduit is at right angles to its length the light should go forward, but if the end is cut at say 30 degrees then the light would tend to be directed off to the side. By being cut at different angles the action of a lens is created.

This has many applications in displays where it is needed to direct the image in preferred directions, for example in 3D. This can replace lens arrays and lenticular lenses. This is then a good example of how a part that is consistent with the inventive concept also has many applications outside it, and so any parts of inventions should not be considered limited in any way by the examples in which they described, but are considered to be shown for the purposes of all known applications they can be used in. For example this assembly could be also used in place of lenses in a camera.

In an embodiment light is refracted into the facets from an external light source, even an image. The bottoms of the tubes instead of having a light source are coloured icons. As light refracts into the tubes according to the colour and shade of the bottoms, a given amount of light is reflected back up the tubes. The facets then have an appearance perhaps of an image according to what light can came back up the tubes.

Preferably the material in the display is opaque but it can also be transparent or translucent and direct light by its shape. For example one might have a window with a display shape formed by grooves that could display an image superimposing what one can see through the window. For example there may be two panes of glass or Perspex that have these groove channels on their inner surfaces. An image goes down these channels and is directed at some points outwardly which we would see as points of light in an image, even though we could still see through the window.

Another application would be any surface in which it is desired to receive signals through it as well as display signals on it. Wearable glasses and helmets in 2 and 3D could also use these devices.

In an embodiment the display would be somewhat flat, similar to a plasma display, and thin to hang on a wall or even be a page in a book.

In an embodiment the signal can come from at least one LCD or similar device, at least one cathode ray tube, and other desirable inputs.

In the case of a display it may be desirable to have more than one input device. For example a plurality of LCD screens could input a signal that is conveyed by the grooves to the display surface to increase the resolution of the 3D display from different angles, or even to improve the resolution of a 2D one. This is because a 3D display usually needs more pixels than a 2D screen has, and this can be overcome by using several smaller display means like the LCD's so that each either forms an image angle in 3D or it may direct its light to a section of the screen for the 3D.

In some embodiments it can be useful to even have 10 or more small LCD screens that plug in and have their light directed up grooves, which would give in this case preferably 10 different viewing angles in the 3D display. This would not be expensive to do and in this case each LCD may be driven by a separate image generating means like a DVD, a computer a video, etc except that they should be synchronised together.

In some embodiments it is envisaged different inputs can be made of different metamer colours to create a display similar to one disclosed in my patent application WO0131384. This has the advantage of giving an image with less distance between the pixels as shown in that patent application. Normally in 3D to increase the resolution and the walk around effect you have to have larger dark borders around each pixel.

Preferably different metamer colours can combine to give an enhanced 2 or 3D image.

Preferably these metamers can also be viewed in different sets by different observers. In the case of a display emitting many different metamer colours viewers may filter out some of those colours to preferentially see part of the information.

In an embodiment say there were 5 sets of 3 metamer colours emitted from a display means, one of which was red, green, and blue. In the art many filters can easily be made to create and filter these metamer colours and when they are mixed together, just as with red, green, and blue a colour wheel shows you can get all colours just like you do with televisions.

The other sets of metamers could be combined so the eye can also see all colours just as it combines red green and blue to see all colours. For example another set of metamer colours could be mauve yellow and aqua, which could be combined to give substantially all colours.

In this case say 5 different viewers for the exampled 5 sets of metamers each wear a different set of viewing filters such as glasses with coloured lenses.

Viewer one might wear glasses with small spots, stripes or other shapes of red green and blue on each lens so he only sees an image made from those 3 colours.

Viewer two has a set of glasses letting through only say orange purple and aqua and can see a full set of colours, though he cannot see the red green and blue image viewer one sees. To clarify this viewer two could see red for example but he might see it as a mixture of orange and purple while viewer one is seeing the red from the screen. Both then would see red but from a different image even though all 5 images were superimposed on the one screen.

In this way five viewers could see different images, movies, advertisements, etc. In another variation each could have 2 colours like the 3D glasses, viewer one having red in one lens and blue in the other, and viewer two having orange in one lens and purple in the other and so on. These would work just like 3D glasses known in the art except each viewer would see a different 3D image.

There are many possible metamer colour combinations along the lines described. In a 3D environment for multiple viewers one could then project individual images for each person by perhaps tracking their positions.

In a preferred embodiment one can also create displays that cannot be recorded by others, just as earlier one display couldn't be seen by another viewer. In effect then viewer can mean a camera or any recording device as well as a person.

Preferably images can then be formed by one set of metamers so they cannot be seen by a camera that uses other set of metamers. For example a normal camera uses CCD's which break the image up into red, green and blue. Such colours can be narrowed so there are frequencies and colours such as orange aqua and purple that don't get through the filters and so aren't recorded by the camera, even though they can be seen by people not using viewing glasses or a camera.

One can then project images, text, and other information in these metamer colours to be visible to actors for example but the camera doesn't record them. A newsreader could have his text displayed or an actor their lines though the viewer at home couldn't see them. Instead of using a green screen, they could project images onto a backdrop actors and other people could relate to more easily and none of it would show up on the film or CCD output.

In an embodiment a display means can emanate various colours and frequencies that correspond to an identifier. To use the analogy of a bar code, colours could be mixed on a messaging means like a tag and by recording the frequencies or the overall colour of it this could correspond to an identifier like the bar code number. Of course this could be used in many other applications and is not intended to be restricted by the examples and context of the explanation. The colours may be mixed together into a tint or separated into different coloured sections in different shapes, perhaps even looking like multicoloured bar codes.

In an embodiment you might have 20 example colours which can be mixed together or otherwise ordered. Whether a colour appeared or not would in this case represent a binary code with two to the power of twenty numbers of combinations, even more if the order or amount of the colours was used to represent a number. This would have applications anywhere where bar codes are used or where there is need for a tag or descriptor.

One can also combine the two forms commonly used in 3D. In my previous patent applications WO9910766, WO0131384, and WO02054378 there were disclosed many surfaces to generate a 3D image. One can also project an image that is split into red and blue, 2 polarities, or shuttering each eye in turn for a viewer to receive a different image for each eye. These then are the two systems, one needing glasses to view 3D and one not needing them. The two systems can be combined as follows.

The two signals, one for each eye, instead of being emitted from a flat display means like in 3D movie theatres, can be emitted from a 3D screen shape disclosed in my previous patent applications and in other 3D screens known to the art.

The viewers wear glasses to give a separate signal to each eye but less information needs to be emitted on the screen and the viewer can walk around and see the 3D image change.

Preferably in the case of the groove display the LCD's and other inputs may be located on the back, side, or somewhere not impeding the display. Conduits as described pass the signal from each pixel on the input devices to the corresponding outlet on the display device and through the lenses, mirrors, and translucent materials used to manipulate the image.

Instead of a flat display like plasma for example, costing a large amount then there could be used an input means like the LCD and the grooved display which may be stamped onto a plastic or paper medium, costing far less.

There can be many other display shapes. Preferably this screen can be made to be flexible so it could be rolled up or distorted in shape like a newspaper or part of a book like viewing device. Layers would be made as before though it is to be understood these layers need not be just flat, but can be of any shapes that can connect together.

Preferably in this case there would be means so parts of the grooves wouldn't crimp undesirably when the shape of the display is changed. Such means would include but not be limited to larger grooves near a folding section or a different cross section and stronger bracing.

In some embodiments there can be a plurality of sections that fit or hinge together, so the grooves in one section abut to the other sections. When the hinge is in one position groves from one section direct light into the others, but when folded there would be no way for light to get from one section to the other. One example here would be a hinge on laptops and similar devices such as a PDA where opening the top would put the sections together and allow light to be directed to the screen. Another would be a screen that was foldable into a smaller shape.

Preferably these screen sections can form complete objects like lamps that radiate light from desirable parts of the screen and can also radiate images from other parts.

Preferably the display means can be also be on items such as furniture or anything desired to project an image.

Preferably these shapes can project information such as advertising signs. In an embodiment one sees neon signs and also backlit transparencies used as signs on shops, etc. In this example a backlit transparency or image input like a photo or slide can project the advertisement through the grooves and onto a desirably shaped viewing surface to mimic all other kinds of advertising and display devices in their applications.

Because such displays would be cheap to make the size and shapes are essentially unlimited. For example one could make displays as big as the sides of buildings looking like a large LCD. One could also create large scale invisibility devices to make even large buildings in a city appear invisible so one just sees the surrounding natural countryside.

In another embodiment light and other electromagnetic radiation can be efficiently collected for solar power.

Preferably receptors collect the light and other radiation and direct it down optic fibres and grooves as described to various central areas. From here the radiation is converted into other forms such as electricity by Stirling engines, photovoltaic devices and converters of all kinds.

Preferably the radiation can also be converted into heat that can be stored to heat other areas such as for example heating a building.

In an embodiment large lenses for example one square meter in size collect light from the sun and focus it into collectors as shown in FIG. 5. Here example lenses A and B collect the light and direct it into reflective funnel like shapes C which in turn direct it into fibres and grooves D. This lens array is disclosed in my. PCT WO02054378 for 3D and other applications but here it is used for solar energy.

The advantage here is that many of these arrays can be cheaply made and collect sunlight and the optic fibres and grooves can collect light and bring it to for example a Stirling engine, even a steam engine. The light heats the example water which is converted to steam and creates motion and if desired electricity.

In effect then if one had for example 1,000 of these small lens arrays which might be Fresnel, or any kind of focussing means even parabolic mirrors, one has in effect the equivalent of a 1,000 square meter lens so the energy captured is quite large. Individual sections can be more cheaply manufactured and connected on roofs, or any desirable location. The light can be routed to at least one power converter device or diverted into a network to be used elsewhere or converted into a storage form such as heat.

Preferably there is a storage container of photons using mirrors, such as perfect mirrors to confine them, which can be released by making an opening so some can escape. These photons can then be used for heating, communication, and all other known uses for light. More light can be piped into the enclosure for storage. This storage device could be used in vehicles and stationary objects with the light collected being converted into heat via a Stirling engine or similar devices, photovoltaic cells and other converting means to other forms of energy.

In an embodiment it would not be necessary to have a medium to store energy in, which is often heavy. Light is stored in a container with a mirrored interior and a vacuum. It can act like a battery for example since it stores light which can be readily converted to electricity.

In another aspect of this invention there is provided a means to convert light and other radiation into a form suitable for transmission down a reduced number of conduits in an organized manner so it can be reorganized later into a form without losing the complexity of the original input.

Preferably this radiation takes the form of an image, moving or still.

Preferably these images are captured by a camera like device using lenses and mirrors.

Preferably this image having been broken up into sections loosely described as pixels can be moved down at least one optic fibre or light conduit. If there were for example 800 by 600 pixels in the resolution of this image then instead of using 480,000 optic conduits it would preferably use one.

In an embodiment a grooved display is made as described earlier to use in this example as a camera. What was the display surface in this aspect can function as the focus plane in a camera which would normally be CCD's, film and other means.

Preferably this surface is flat but it can be other shapes such as parabolic, cycloidal, and semicircular. The optical conduits collect the image and it flows to a collection area to organize this data into a serial form. An embodiment of this is described in my patent application WO09910766 page 23.

Here a laser shines light into a circle of optic fibres or channels which direct this light onto a display screen. In the embodiment here light flows back from a similar display screen into a shape to collect the light from. In this case a ring is a good example.

In the case of 480,000 pixels referred to then there would be 480,000 points where the light is funnelled to around this ring though other shapes can also be employed. Conversely these points could also be collecting a signal as in the earlier patent application so the inventive principle is the same.

Preferably then a mirror like device collects light from each of these points in turn as it rotates or moves in a predetermined pattern. Its movement directs the light down an optical conduit so that each point's signal is placed in a queue of light that travels down this optic conduit. It may be desirable of course to use more than one collection point, and more than one fibre to spread the signal load. There can also be many rings of these emitting points each collected by the reflective or other means and directed into more than one optical conduit. It may be desirable to use lenses and such like to focus this light onto the rotating mirrors and into the conduit.

Of course the rotating mirrors are just an example for a directing means from the grooves into a reduced number of conduits in a substantially serial form.

At the other end it would be similar to in the previously mention WO9910766 where a rotating reflective means directs the light into perhaps another ring which transfers it to another screen, a CCD array, film and other collecting means. In other words at the other end the inventive principle is reversed to recreate the image.

This allows an image to be transmitted along an optical conduit without needing to convert it to an electrical signal, or to digitise it. This has many applications, anywhere a camera is used to collect an image or data and transmit it to a recording or display means.

An embodiment would be to direct the signal to a wearable display such as glasses or a helmet array as described in WO09910766, giving 2 or 3D. of course any other receiving means is also suitable.

This gives an advantage of transferring a large signal down a thin cable, which is less bulky. One could have receptors to capture a 2D or 3D view and instead of having to convert it to electricity with CCD's and being constrained by its limitations one could transfer the signal in, in this example analogue optical form to the receiver, recorder, or viewer. In other embodiments digital signals can also be employed.

Such a display preferably could combine a received image with a view through the glasses itself.

Preferably it incorporates a receiving means of an image and combines it with a receiving means of another image source.

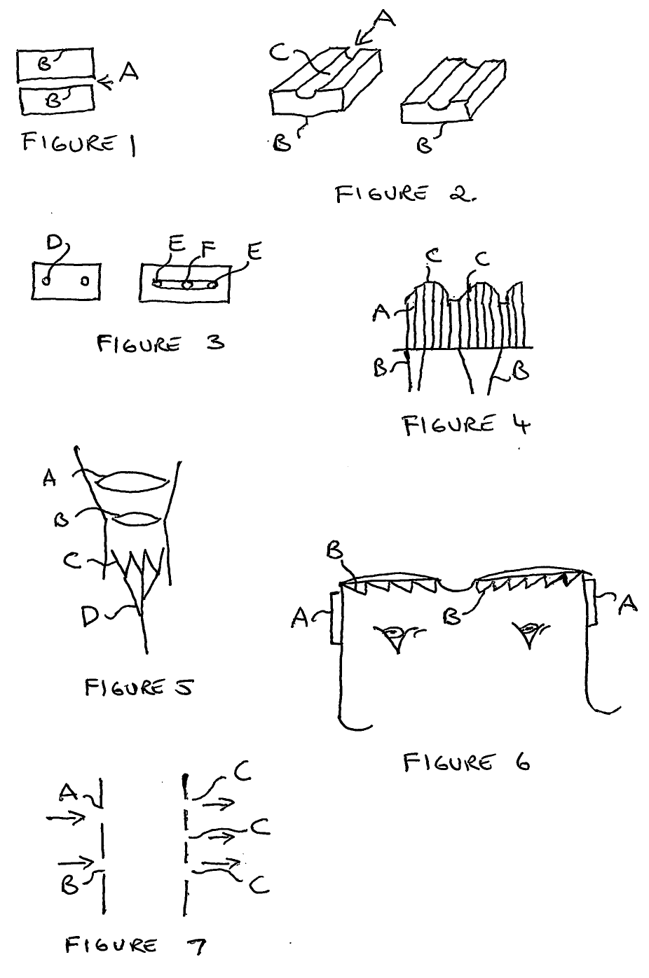

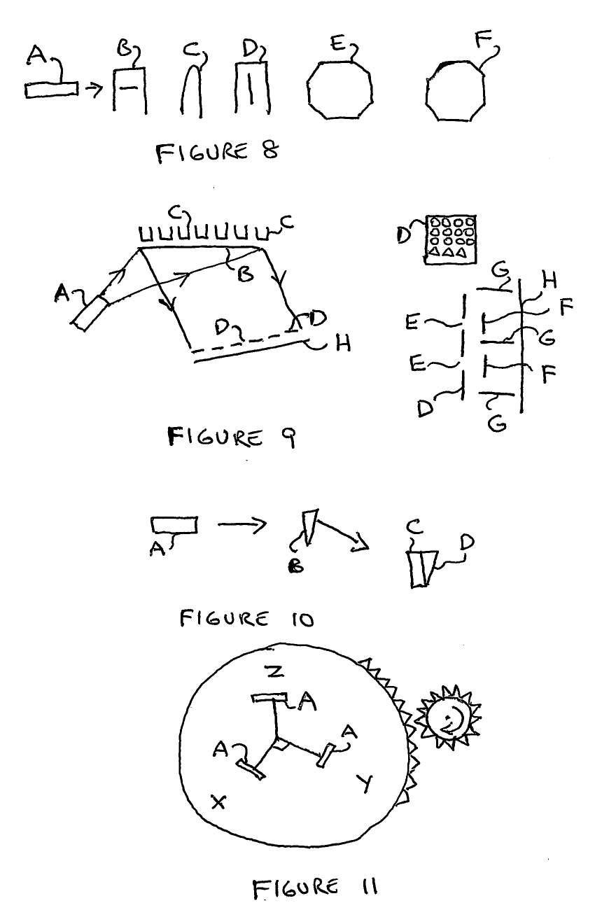

In FIG. 6 the glasses have a series of facets B that would direct an image from the LCD or other emitters A or optical inputs such as for example those just described. The eyes can also look forward and see through the glasses though the facets would tend to move the image seen to one side slightly. The glass may be partially coated like a one way mirror so there is some reflection to assist seeing the image as well as through the glasses or other imaging means.

Preferably the facets can be any number or shape but would be relatively small and be designed so as to facilitate clear reading of the small displays.

The camera or receiving means could be underwater, outside a plane, or anywhere inconvenient for an observer to be himself.

This signal can also be boosted by the following means to send over larger distances.

Preferably there is a means to input an electromagnetic signal of a given mix of frequencies and intensities and boost it without having to convert it to a digital form though this can also be used for digital information.

Preferably the signal enters an aperture A of a size so the signal spreads out as shown in FIG. 7. Another signal preferably not varying enters the other aperture B. The at least two signals form an interference pattern some of which goes through the apertures C, and other parts of which can go through other apertures like C.

The exiting signal then would be stronger than the original modulating one though the contrast between stronger and weaker parts would be lower. This is because C would be positioned to be at an area of constructive or destructive interference, so as for example the beams interfered with each other the output beam would vary according to the signal being sent. With multiple apertures like C more of the signal can be outputted and collated together.

The second beam B may also be of a different frequency but harmonically related. For example it might be 2 or 3 times the frequency of the signal beam, so it can be separated later. Also in this step it may be desirable to simply mix together beam A and B.

Next it may be desirable to improve the contrast of the signal. As an example this can be accomplished by the beam goes through a polarising means preferably using an electromagnetic field or slit. This is adjusted so the weaker signal parts are bent more by the field or slit than the stronger parts, because a for instance magnetic field when adjusted to the right strength would change the polarisation angle of a weaker beam more than a stronger one. The signal then points in substantially one direction in its strong parts and another in its weaker parts, especially if it is a digital signal. The beam may go through a plurality of such arrays to increase this difference of angle each time.

Then there are means to filter out or attenuate the weaker signal because of its differing polarizing angle. An embodiment would be to send the beam through a slit adjusted to cut out more of the weaker signal by having the slit at substantially 90 degrees to its polarization. Another would be to have the beam reflect off a surface so one part of the signal is reflected and other refracted according to the angle it strikes the surface. Also they might be reflected or refracted at different angles making them easier to separate. The weaker signal is retained or discarded as desired, even recycled to be boosted again or for other applications.

Another embodiment is to send the beam into an interference apparatus as described in FIG. 7. The weaker parts of A would be destructively interfered with by another beam B if it has substantially the same polarization angle while the stronger parts would be less attenuated since they would have a more different polarization angle to B. The resulting beam might then be polarised to combine the remains of the second beam with the signal beam.

In another embodiment a beam can be sent down multiple channels in this way. By altering the polarization of a beam at selected times as before instead of discarding part of the signal in the objective of increasing signal contrast one might for example desire to direct the beam down one of a plurality of channels something like a switch.

In the case of two channels, altering the polarity of different parts of the beam may make the beam reflect off a surface with one polarising angle and reflect at a different angle or refract into the surface and so the polarising angle acts as a switch.

In an embodiment another switch mechanism would be that the beam reflects off a surface at different angles so altering the polarization can direct the beam into one of a plurality of separate channels.

In an embodiment another switch mechanism would be as in FIG. 7 where altering the polarization of A would cause the two beams to at times interfere destructively and emit less at B.

Of course this has many applications not at all limited by the examples shown. One would be to boost optical signals over long distances but all applications of a means to boost the strength and contrast of a signal beam are envisaged.

One related application would be to create windows and light shutters. In an embodiment a window has lines of substantially parallel or other patterned wires, preferably small or transparent and generally hard to see. The glass would have a polarization at an angle. When power or other means is applied to the wires or other polarising means this polarises the light to an angle substantially different from the polarization angle of the glass so it is substantially attenuated in going through the window. This can act like a curtain or shutter in a dwelling or any other application including as an optical switch.

Some other preferable applications would then be to act as an optical transistor, in some cases to boost optical digital and analogue signals over larger distances. Also of course all applications using these methods to emulate electronic components are envisaged as well such as in logic circuits for example. FIG. 7 in many ways functions as an optical transistor. There are many varied uses for transistors known and these could be used in this way with light instead of electrons.

According to another invention there is an electromagnetic signal, a reflective or refractive means to vary its direction in one axis and a reflective or refractive means to vary its direction in another axis.

Preferably these can direct the signal to different locations to form a desired pattern of light such as an image.

Preferably this is directed onto a screen of a predetermined shape from behind or in front in many ways like a projector.

Preferably one directing means moves the signal from side to side and the other directing means moves it up and down thereby covering all desired parts of a viewing surface in turn. This may be done in a periodic manner or means may preferably direct beams in irregular patterns onto the display means.

According to a preferred embodiment a light beam is created of a desirably small cross section. Preferably this is white, but also multiple versions of this apparatus can modulate red, green, blue and other metamer colours as desired.

Preferably there is an arrangement of electronic devices to emit an electromagnetic field like an aerial does.

Preferably this field is a long and narrow shape that the beam can pass through like a piece of wire in the shape of a hairpin, though all kinds of shapes, multiple wire arrays and so on are envisaged. As current passes through the wire it would tend to create a magnetic field capable of altering the polarization of a light beam.

Preferably this current can be a signal to be translated into an optical signal by altering the polarity of a light beam.

The light beam is polarized in for example a horizontal angle by perhaps a slit and passes through the hairpin like wire shape which might be orientated vertically. As it passes through the wire the strength of the signal alters the angle of polarity of the beam similar to as described earlier in the examples of increasing the contrast of a light beam signal. In effect then a weaker current would alter the polarity of the beam less than a stronger current would. This could then be a digital or analogue current signal translating into at least one varied angle polarized beam.

Next it goes through a vertical slit or polarizing means, so that the amount of deflection the wire or other polarization angle changing means gave the beam determines how much gets through the second slit.

In effect then the strength of the signal is converted into substantially the amplitude of the beam, and when this beam is projected onto the screen so it covers desired parts of the screen somewhat like an electron beam does on a cathode ray tube you have an image.

Conversely light such as solar radiation can be polarised and pass through a series of wire light arrays like parallel wires. The light is converted partially into electricity in the wires and the remaining light can be repolarised and sent through wires like this over and over again to draw power, in effect acting like a photovoltaic means.

The inventive concept then is to either alter the polarization angle with a current to modulate a light beam or to change the polarization angle of a light beam so it induces a current in a wire or inductive means, because light is an electromagnetic wave.

One advantage of this is that no matter how rapidly the current in the wire array changes the beam modulates as quickly, so it would be suitable for making a particularly high resolution image suitable for but not restricted to 3D.

Preferably there is one modulating array but the beam can also pass through a plurality of modulators each of which adds an additional signal to the beam. This may be desirable to reduce the load on certain parts of the circuitry and also so that different image producing means such as different computers can multitask together.

Preferably the signal is from an electronic source such as a computer but it can be one or more videos, DVD's, or any source of image and signal information.

FIG. 8 shows a preferred embodiment. A is a source of electromagnetic radiation, preferably here white light to give a monochrome example. B is a means to horizontally polarise the beam. C is a means to alter the polarization of the beam according to the amplitude of a signal. D preferably changes the polarization so that parts of the signal more altered in polarization angle pass through it wile those less altered are attenuated or blocked. Alternatively it may be designed to let through parts of the signal less changed in polarization angle according to preference.

E is as an example a substantially horizontally orientated faceted wheel that rotates at a predetermined speed. The facets can be curved to act as a focussing means or flat and in some embodiments at different angles. Preferably this speed would synchronize to a given number of frames per second. Say the edge of the wheel is faceted so that there are 8 facets on the wheel.

Preferably each facet is regular but it may be desirable to angle the facets to more easily direct the beam to a given direction. Also in some cases the facets can be of irregular sizes. As the beam plays along a face and the wheel is rotating it makes the beam, if it then reflects onto a screen, appear to move from side to side, left to right for example.

As the wheel rotates each facet makes the line move from side to side, then it starts back on the left when it gets to the next facet. In an example of 20 frames per second it would be desirable for the beam to go back and forth 20 times a second on the screen, so the number of facets should be synchronised to the frame rate. You might have 20 facets on the wheel and it rotating once per second, or 10 facets and it rotates twice a second and so on in any desired combination.

Preferably the up and down motion is confined to another wheel F substantially rotating vertically though it can be on the same wheel. The beam or beams if say red green and blue beams are transmitted separately onto the same rotating wheels, shines from the wheel E onto facets of the wheel F. F rotates more vertically and so directs the beam to go more up and down on a display screen. When properly synchronised with the frame rate of the image the motion of the two wheels will cover substantially the entire screen with the desired image.

The advantages of this method are that the wheels can be synchronised with cogs or belts and so the picture would be unlikely to go wrong. Also it puts the variation of the imaging means onto the exampled B, C, and D instead of needing circuitry at each pixel like in an LCD.

Of course B, C, and D can be replaced by any devices capable of modulating the beam fast enough, as for example lasers switched by sound waves can do in the art. Rather than detail all these known modulators B, C, and D are used as examples. Also the wheels are examples of means to cover a display screen and are not intended to restrict the ways of doing this. For example in my patent application WO9910766 I detailed in the priority document uses of mirrors that vibrated from side to side to direct light onto a display screen, which is the same inventive concept.

Preferably the beam modulation has means for detecting the positions of the wheels or devices that perform an equivalent function to the wheels so as to synchronize the image properly. For example as a wheel rotates at a certain part of the rotation it may activate a switch like a timing mark indicating a new frame should be sent.

According to another invention there is a an light emitting means, a means to deflect parts of the image and a masking means so that parts of the image deflected fail wholly or partially to pass through the mask onto a display screen, shown in FIG. 9.

Preferably the light emitting means can contain images and data.

Preferably it can project monochromatic light as a steady source or selected frequencies such as red, green, and blue and other metamers.

Preferably this projected electromagnetic radiation is broken up into sections resembling a pixel array on a monitor.

Preferably a monochromatic beam A is used though of course multi coloured beams can be used.

This beam is shone onto a refracting or reflecting means such as a mirror B. B can have behind it electromagnetic means or other means to alter the angle at which the light reflects off B. Each of the icons of C as an example can be an electromagnet which can alter the reflection angle.

Preferably this mirror B is flat though it may be curved to create a magnifying or image altering effect. It may do this to perhaps make a larger picture.

The reflecting means B takes the light that falls on it and reflects each pixel like part onto a mask of holes D preferably with each hole corresponding to a pixel. Ideally each hole in the mask corresponds to a reflective angle altering means C.

If all the light is reflected accurately through the holes then the light pattern on the viewing screen would be all white. If all the light was deflected by the example magnets then the separate beams for each pixel would hit the material between the holes on the mask D and the screen would be blank. Hence by varying the magnets each pixel can be modulated and an image displayed. The strength of the magnetic field can be modulated so a pixel beam hits part of the mask material and so part of the beam gets through the hole corresponding to modulating the intensity of the beam.

The light emitting means could be a light source like a bulb that after passing through a series of focusing means like lenses gives a preferably parallel array of beams one for each pixel though this is not always needed. In some embodiments a single beam, wide enough to cover the entire screen B is sufficient. If the beams emanate from a small source the reflector B may need to be curved to direct the beams through the mask.

The beam can also be modulated by altering the shape of the surface B such as by moving it by for example micro mirrors designed to tilt with a signal. It could also be done by vibrating that point such as with sound. Of course similar effects can be done by refraction, if the beam passes through a material instead of being reflected off.

In another embodiment the beam reflects or refracts from a magnetised point as before, but this additionally acts as a prism to break the light into a spectrum. At various points then on B there may be small prisms or other means to give the same effect. The beam reflects off B of course modulated by C and directs this beam now separated into different colours onto the mask D so a predetermined part of the spectrum goes through it. For example the beam may be directed so red goes through, or blue. It may also allow a wider selection of frequencies to go through, which will still be seen as one colour in that pixel since the eye tends to average the frequencies when coming from a small enough aperture. For example it may allow through blue and green which the eye will interpret as the average of those frequencies as a colour since the pixel is relatively small. In this way more of the light, even half of the spectrum can go through the aperture to not waste as much light.

To make the pixels closer together each aperture E on the mask D could have a diffuser F after it. The beam hits the aperture E which lets through a colour according to the angle it strikes at, since the beam is colour separated by the prism like means.

The light then goes into the diffuser F which spreads the beam out into a larger width preferably to abut the other pixels with the result is there is a minimal dark space between the pixels. In this example there are barriers G so the light doesn't go into neighbouring pixels if desired, though F can also be a lens array that focuses the beam so it wouldn't interfere with other pixels. H is the display screen. This of course can be used in many other applications not limited by the above examples. It might be used in any display where it is desired to reduce the darker boundary between pixels and in many other applications. Also it can be used to separate colours and modulate them to send in optic computers and data systems.

In one embodiment the beam is a data signal, the surface B can also be replaced by a refractive means, the magnets C can be any modulator to change the angle of the beam known in the art, and the aperture E can also modulate the beam as desired.

In an embodiment the reverse can be used to take images through a camera or data receiving means, and record the colour without needing coloured CCD's or film.

The light goes through lenses etc. as in a normal or 3D camera and on the focal plane there is a means to preferably bend the beam that falls on a given point or pixel according to its frequency. In effect it acts like a prism and the focus plane would be covered somewhat by small prism like means such as one for each pixel. It may also be desirable to use one prism means for a plurality of pixels taking care that each pixel doesn't get mixed up with the signals from the others. This is shown in FIG. 10.

A beam A comes from an object to be imaged or is a data signal. It goes through lenses and focussing and routing means to fall on a pixel or data point B which has a prism means. The beam then goes off at a varying angle according to its colour or frequency onto a recording means. Here as an example only this is done by two slits or detections means C and D. The light falls partly on the constant width slit of C which records the intensity no matter at what part of the slit the beam hits, and also partly falls on the tapered part D. The intensity here will be recorded differently according to the deviation and hence the frequency or colour of the beam, so the intensity through here will correspond to the frequency.

This may be in turn captured by CCD's, film, and other recording means, making the assembly potentially smaller. This is because instead of needing 3 CCD's for red green and blue one can use a smaller means such as in the example of C and D. Of course this can also be used for any optical circuitry and manipulation of electromagnetic radiation known to the art.

This is just an example with a display to show how the different parts can work together in this context. Each part of it can equally be used separately in another invention or in combination with other parts in all applications known to the art. Of course the same applies to all parts of this application. The claims best define the scope of the invention and various parts of it.

In an embodiment a movable means with colour sections is used. This may spin or move in any way, and the signal can bounce off it or pass through it. Of course it can be any lens or mirror shape to focus a signal as well.

In an embodiment the signal passes though a spinning transparency with different colours like a colour wheel. It may have red, green, blue, other metamers, even all colours on it. As the colour signal passes through it some colours are allowed through and others blocked.

For example red would be blocked going through it when the blue transparency was in front of the beam. This is recorded preferably monochromatically and one skilled in the art can reconstruct the colours of the beam, on the principle that knowing at a given time which coloured section was being reflected off or refracted through that section if dark was that colour or dark anyway.

If the example wheel spins quickly then this can be worked out when compared to when another colour section passes in front of substantially the same scene. This is encoded and the colours of the images or data are inferred.

In an embodiment, the focus plane can have one or more lenses or reflective mirrors which redirect the signal onto CCD's or recording means in another location. This conversion can make the image on the focus plane larger when it is refocused elsewhere and so more units of the recording means such as CCD's can fit in the image size to record the image.

This then works as if the CCD's were able to be made more densely. Of course this can be applied to all kinds of camera and recording devices.

In an embodiment the focal plane can be represented by CCD like detectors on appendages like wires or movable means. Manipulating the lengths and positions of these detectors and appendages one can place these at the focal plane or a preferred location without necessarily changing the lens such as in focussing or zoom lenses.

One can also move the recording means here CCD's apart or closer to each other to mimic the functions of a zoom lens. The same applies where the appendages can be linked together in any array. They could also be light emitting elements such as LCD pixels for example. One application would be as a LCD like panel in a projector that could be expanded and focussed instead of the usual methods of zoom lenses and focussing. Also the focal plane can be flat, curved or irregular as desired.

In some embodiments the focal plane would be deformable into an irregular shape to act as a kind of adaptive optics. For example in an image that had objects closer and further away the focussing plane could have some sections in a position to focus on closer objects and others to focus on further away objects. Of course this also applies to all kinds of focal planes and means to manipulate the recording means in that plane, not limited in any way by the context of this example. It might equally be used with a normal focussing plane in a video camera for example.

In an embodiment algorithms are used to determine how to shape to shape the focal plane to give a preferred focus to certain objects. The algorithms determine an optimum focus by changing the positions of the recording means, in this case CCD's. As the image recorded moves in and out of focus the contrast between selected CCD's changes. Generally the sharper the focus the more the contrast between pixels. The blurrier the focus the less the contrast. By applying an algorithm to move the CCD's to substantially maximise this contrast the optimum positions of the CCD appendages can be worked out for focus.

Also CCD's can be moved closer together for sections with more detail and further apart for parts of the image with less detail, and for other desirable reasons.

In an embodiment the receiving means such as CCD's could be mounted on a deformable or stretchable material and adjusted by squeezing, inflating, attracting by magnets and all other forces known to the art into the right shape.

Another embodiment relating to FIG. 8 is to polarize the light at points on the reflecting means B by devices C and have the holes in the mask D polarized in a different direction, or a separate polarizing means also modulating the polarization. That way the pixel beam is polarized one way at B and then stopped from reaching the screen H, and can be polarized another way at B or E to reach the screen.

Essentially this can be like the operation of a LCD except instead of passing though two polarized sections; the light is reflected off of one of them and passes through the second. To regulate a pixel, B or D would be able to be modulated in polarization angle. For example a beam of light hits a point B and device C polarises it horizontally. D's holes are polarised vertically so the beam can no longer go through it. By regulating the devices C the beam can be modulated.

Alternatively the hole in D can be modulated, perhaps by varying the polarization. Just as in the relationship to LCD's this inventive concept can be extended to and mixed with other display means.

According to another invention there is a way to improve seeing through fog.

Preferably there a light emitting means such as car lights and a means to direct light in a plurality of smaller light beams separated substantially from each other.

While this would preferably be used on vehicles it could also be used in other areas such as on boats.

One of the major problems with fog is that light is reflected back by the fog so that we don't see the road for example.

In the preferred embodiment the light comes from sources substantially similar to car headlights and fog lights except that they emit multiple beams of possibly varying shapes.

Preferably each headlight emits beams of light. Each beam is by example only of 3 degrees of arc. There will be substantial gaps between the beams which are optimally distributed so that instead of seeing a wall of reflected light we only see shafts of light with areas of dark between them. Particularly if the lights are affixed not in front of the viewer, such as on the passenger side of a car, one can see the beams of light from the side going into the fog, and when they strike objects we see the beams terminate. From this information we can judge more accurately what is in the fog.

Also in these darker areas we would be more likely to see light reflected back off the road and other objects as our vision is not as dazzled by the reflected light in those areas. Consequently we see more of the road through the fog.

In an embodiment different beams are of different colours so the colours reflected back from the road give more information about it.

Preferably the beams can be round, square, rectangular, in a grid, or any shape. They may also be of different intensities and some may connect to others so a reflection can be construed as coming from a particular beam.

Preferably this light is a constant source but it can also be modulated according to pre existing knowledge of the terrain. For example radar like means can see the terrain and give us a picture through the fog. By modulating the beam with different colours and shapes one could impose on the fog a shape of the road beyond, in effect using the fog as a projection screen and the lights as a projector. Also icons such as arrows, speed and other information can be superimposed on the fog, even pointing to objects we may not see clearly. In some embodiments it may not be necessary to break the beam into sections.

In one embodiment a display means such as a small LCD projector plate is mounted inside a car light, behind the bulb with a reflector behind that. Modulating an image on the screen will then transmit an image onto the fog and terrain as desired.

According to another invention there is provided a means to moving faster with less energy through a medium.

Preferably this medium is a liquid such as water and ships and submarines are moving through it, though this can also apply to air and solids like soil.

Preferably the outer surface of these craft is able to move so as to reduce the relative speed of the water flowing over the surface of the craft.

In a preferred embodiment the craft is a flat bottomed boat to illustrate most easily. The surface of the boat that comes into contact with water is covered substantially with a movable skin. On other craft the whole surface coming into contact with the medium such as water is also covered with this movable skin. This skin is designed to move backwards as the craft is moving forwards so preferably the water is stationary relative to the skin. For example if the craft is moving at 60 miles per hour the skin is moving backwards at 60 miles per hour and because of this there in effect reduced friction with the water.

This skin is preferably in roller sections resembling the tread of a tank, but wider. Each tread in this example is configured so it can be moved by the rotation of cogs or other rotation means like the wheels of a tank move the treads.

The bottom of the boat is configured so in this example all the bottom of the boat is covered by these treads. In effect then all the surface of the craft can be covered by this skin. In some embodiments it is preferable for the hull to have substantially flat sections so fewer and larger pieces of skin are used.

Preferably the bottom or outer surface of the treads protrudes into the water while the inner surface is not in contact with water but inside the boat, or at least inside a container.

Preferably there is a means to prevent water entering into contact with the inner parts of the tread. Air pressure, tight seals around the entry and exit points of the tread, and pumping water out can also prevent water friction on the inner parts of the skin and treads.

As an example it is desired to do 60 miles an hour in this craft though it could normally do only a fraction of this. The treads are rotated to 60 miles per hour and additional propulsion means such as propellers are turned consistent with this speed.

The treads preferentially have fins on them though they may also be smooth or in other configuration. Fins pointing longitudinally may assist to keep the boat straight and latitudinally may assist to grip the water and provide thrust.

Preferably the treads cover substantially all the surface in contact with water. When moving there is little or no friction with the water since the treads are moving at the same speed as the water is going past the craft. The friction then is the same as if the boat was stopped. Because of this the boat experiences little drag.

To illustrate this better another embodiment is a submersible vehicle. At the example speed of 60 miles per hour the craft experiences little friction as the treads are moving as fast as the water. Since there is little friction there is no reason why even much faster speeds could not be attained.

According to another invention there is provided a means to alter the orinetation of an object and to resist outside forces in altering its attitude, shown in FIG. 11.

Preferably there is a means to spin gyroscopes in selected directions. In the preferred embodiment these are spun in the X, Y and Z axis and in a rigid frame, so their orientation doesn't move substantially relative to each other. Gyroscopes in this configuration would form a unit that would resist being turned. One can experience this with a top. In this embodiment though, the resistance to being turned is in all 3 dimensions. In FIG. 11 there are 3 gyroscopes A, connected in a rigid frame and pointing as shown in preferred directions.

This gyroscopic array might be enclosed in a sphere for the sake of example only, though it could be any shape at all. On examination it would have some curious properties, especially if you didn't know what was inside. If you tried to turn it in any direction it would resist that motion just like a top would. If it was on a slope it would resist rolling down it.

Outside the gyroscopic assembly there are connecting means to other objects. This can include but not be limited to cogs and belts. The inventive concept here is to be able to reorientate the gyroscopic assembly with any mechanical means known to the art.

Preferably the vehicle is a helicopter for example only. As is known a helicopter needs a tail rotor to counteract the rotation of the blades or the body would start spinning in the opposite direction.

Preferably the gyroscopes are spun in the 3 axis directions and are in a geared assembly shown in FIG. 11. If the gyroscopes weren't spinning this assembly would enable the gyroscopes to be tilted in any direction by turning the gears. If they are spinning then not only is it harder to turn the gyroscopes but there is a tendency in turning the gears to rotate the external assembly while the gyroscopes don't change their attitude. In effect then by attempting to turn the orientation of the gyroscopes you tend to turn yourself instead.

If this was on a helicopter and bolted to the floor it would then tend to slow the counter rotation if the tail rotor was turned off. If the cogs are turned so as to try to turn the gyroscopes they will resist turning, and in fact will likely turn the helicopter. If the gyroscopic array is attempted to be turned at the right speed, this will result in the helicopter being turned in the opposite direction. This turning can be adjusted so as to keep the helicopter straight without needing the tail rotor.

It can also be used to change other orientations of the craft. For example the helicopter can be pointed up or towards the ground, or be banked to the side by trying to turn the gyroscopic array.

Another example would be to use this on a boat where turning the gyroscopic assembly would instead tend to turn the boat around. This would be useful for example in larger boats like oil tankers that are difficult to turn. Here they could be turned with no external propulsion at all, and also their steering could be assisted in this way.

In another preferred embodiment planes and missiles could use this to change their attitude without needing to use wind resistance and vanes. A plane in a stall for example could change their attitude and even in a tailspin could regain control. A bomb falling could change its attitude to point in a preferred direction and steer itself as if it had vanes on the sides.

Some variables are the weight in the gyroscopes and their turning speed. If weight is a problem they can be designed to turn faster or their speed can be varied as required. Also a mirror image array can be spun in symmetrically opposite directions to cancel out any drift from the preferred orientation. Depending on the application some wheels can be spun faster than others or there can be fewer or more wheels in irregular angles.

A vehicle could be powered by placing a gyroscopic array on it which is connected to the wheels by a gearing means. Trying to turn the gyroscopes turns the gears instead which is translated into forward motion.

According to another invention there is provided a means to alter computer code by a predetermined, chaotic or random pattern that still enables the program to achieve a desired goal.

Preferably this altering of code can happen from pre-programmed instructions or from external stimuli, both friendly and unfriendly.

Preferably this can involve reordering of instructions so code executes in a different order.

Preferably this involves the renaming of paths and positions such as directories while retaining the knowledge of this renaming. For example if a given set of files is in a directory named A then it may be renamed B remembering the former name and redirecting selected data to the new address. Malicious code may need to find A but does not have a way to find out what it has been renamed to or where the new location is.

Preferably this altering of code can take place in real time, according to a predetermined timetable and according to outside events. It can also occur according to random instructions generated by random or pseudo random inputs and code.

Preferably this mutation of code can create new files by altering older ones, breaking them up into new pieces and put pieces together into new files in any combination.

Preferably this mutation can change the function of for example executable files into data files, and from any attribute or ability to any other known in the art in hardware or software.

Preferably this mutation is to evade outside agencies from influencing and changing the instructions undesirably. For example viruses, Trojan horses, hackers, patches, and cracks.

According to a preferred embodiment there are programs to be executed on computers, such as PC's running commonly known processors and equipment such as motherboards, CD's, soundcards and so on. It is to be understood however that there are many different types of computers and this is a general application for any computing device.

Say for example a program has an algorithm inside it for determining if a serial number is of a correct form. There is a standard tactic to evade hackers in that a serial number placed into Windows for example has to be exactly right, or so complex that it would take a long time to guess. It can be cracked easily however by comparing many acceptable passwords and serial numbers and deducing mathematically the algorithm that generates them.

Preferably in this case the program would generate a large number of algorithms that may be variations of at least one or substantially unique.

Preferably these algorithms can accept a random or pseudo random seed to form a serial number of desirable length. Ways of creating random inputs are well known in the art.

Further, the program can randomly or according to a predetermined pattern decide which algorithm to use to create the serial number. Say for example it used 10,000 algorithms, and picked one of them to generate a serial number for that computer based on a random seed or some random variables. A hacker would have to check many thousands of serial numbers to guess some of the algorithms.

He might then be able to make up some fake numbers but he would be unlikely to make a program to generate consistently acceptable serial numbers as his algorithms might only coincide with the correct ones some of the time. With enough complexity, serial number generators used by hackers would be ineffective.

Also the software example can generate a unique serial number whenever asked, even though it may itself be a pirate copy. This serial number may request a special unlock code conforming to other algorithms perhaps only known by the manufacturer. In that case he might check the program was acquired legally before giving an unlock code to run it. Without the code the program could be useless.

It would also take too long, perhaps millions of years to run the program over and over till a known unlock code happened to fit with the generated serial number.

In another embodiment there is a program capable of mutating its method of installation on hardware so its file names, file locations, paths and other characteristics can be randomly different or altered according to a predetermined pattern each time it is installed. A hacker then couldn't compare installed parts on different computers to hack them. Also a patch designed for one computer wouldn't work on others.

Preferably the code contains redundant sections that can be used occasionally to execute an operation but if hacked the program can sense this and either go another route or deactivate. It can also change randomly or in a predetermined way how and where the code will execute and in what order. This also has the advantage of having many ways to operate so if the program is damaged it may still be able to function. Since the programs can execute instructions in many different ways any patch or hack would only work if the computer happened to be executing in the way the hack was designed to work.

The inventive concept here then is similar to encryption. Just as in codes where we have to try many variations to find the encrypted message, here we have to try many ways to find out how the programs are doing things. In effect then this could be described as encrypting actions rather than encrypting text. Another good analogy would be encrypting dynamic processes instead of static ones. It is envisaged all encryptions methods known in the art could be adapted to work on processes like these.

Preferably details of these mutations would be stored in concealed repositories in the computer so that it would be possible to reverse them and restore some or all of the installation to a standard form. This may be useful to install updates and patches for example, by unmutating parts of the program to the point where an authorised patch will work on it. Of course these alterations can also be mutated to fit in with the unique configuration on the computer, so the patch or update becomes compatible. In this case some special authorization would be required to install these updates.

Unauthorized alterations would be unlikely to succeed because a hacker would not know what the configuration was, and each computer could in principle have sufficiently unique code that any patch or hack wouldn't work. It would probably just stop the program or have no effect. The program would likely either be corrupted by an unauthorised patch or it may be executing in a way that the patch is not effective, since the code can mutate at different times.

A hack that only worked occasionally would be useless. Parts of the code that are targeted for hacks may be preferentially mutated with enormous numbers of variations whereas other safer parts may not need mutation. These mutations can also be directed in relation to Artificial Intelligence to improve their operation, or to generally work towards goals of computer intelligence.

In the process of this mutation sub programs and files could be created on the storage mediums like hard drives and in RAM memory and then in turn be altered and perhaps erased. To follow this mutation would be very difficult as it would be happening in the computer memory. For example an installation might mutate files in RAM randomly hundreds of times before finally writing them in a hard drive.

In another safeguard the program may be designed not to run if not sufficiently mutated to prevent these safeguards being removed, by comparing parts of code to a template and stopping the program if it matches too closely.

In another embodiment there may be a means to notify the program of attempted hacks and viruses in the past similar to the way an anti virus package update works. This may introduce new suggestions, seeds, and algorithms for mutations or trigger preferable mutations to counter the attacks. A program may log onto a web site and download files safely with this information, perhaps partially based on its current mutation, and upload its experiences to compare and build new mutation strategies.

Since there can be billions or more of ways a program can mutate in nearly every part of its operation and this mutation can change over time, and because all of this can happen by a random or predetermined pattern to be hard to anticipate, it is unlikely an attacker could work out what the program is doing enough to alter it.

In effect this can also function as a code where the program contains information that cannot be released without authorization as its mutations protect it.

In another embodiment a program may when starting use various inputs to read a somewhat random piece of data and then use that to do an unexpected action.

Preferably this would involve reading part of a CD where as the CD speeds up no one knows how the CD was placed and if the speed of turning is not known exactly and the speed of movement of the laser also varies then after a given time, preferably as the speed is increasing the laser can be made to read an essentially unpredictable piece of data on the CD, hard drive, RAM, or whatever is being read.

Using this seed the program can for example generate a serial number or operation that can only be cracked as shown earlier with great difficulty.

In a preferred operation when a music or video CD is played, this may in a similar way generate a unique unlock code to be input to use the contents, which may be perhaps obtained online from the owners of the material. Next time the CD is used it might generate another unique request for an unlock code. It may do this for example every 10 times so one could watch the example DVD 10 times in that machine before needing a new unlock code. It might also allow the CD to be watched for a predetermined length of time like 7 days before requesting a new unlock code. In this way according to the inventive concept of mutating code even copying CD's and DVD's would not allow them to be played without authorisation.

Preferably this unlock code would be needed while the CD was still in the drive, but the machine may be programmed to accept it within say 7 days or it will request a new unlock code next time. This can be a software program in a computer or a hardware program in a playing means like a DVD.

In another mode the program may allow the material or program to be watched, executed, installed and so on for a given number of times or length of time before requesting an unlock code.

In another embodiment a file playing means may keep and get updates to a database of characteristics of files such as music and video. When it receives a file with such characteristics it may act to generate an unlock code. Example applications are MP3 and DVD players.

For example someone may download a program or get a DVD of a movie. The hardware in a viewing device like a DVD or software in a computer may allow it to be run for a predetermined time like a preview after which it generates a request for the unlock code.

Of course the programs doing this can also be set to mutate as discussed to evade hacking attempts.

According to another embodiment CD's could be doped with errors on their surface on selected tracks so when the information is burnt, these errors translate to random errors in given data tracks, which in effect give that CD a unique serial number though random. Since there are so many possibilities this is likely to be a reasonably unique imperfection and can be treated as a random serial number of that CD or DVD. For example many CD blanks can have the same imperfections, but the burning starts at different points on the disc, essentially making the error's position random. If they are located in sections with unnecessary information the errors can be a unique serial number, as it is unlikely another CD would have them in exactly the same place.

For example the pits on a CD are very small. If there was an imperfection on a track say 10 pits long, and this could be randomly anywhere on the track, the number of possible positions would be the number of pits on the track divided by 10.

In another embodiment CD's and many other storage mediums use error corrections so any loss of information from a scratch can often be recreated. Deliberate errors can be made on a CD for example so the original information is wrong or different but the error corrections change it into something else.

A CD player for example could be built to detect these predetermined errors and alterations, something that wouldn't be there if a burner made a copy. If these discrepancies weren't there the controlling hardware or software may elect to not play the CD. As long as this was not licensed to companies making burners it would be impossible to make copies of CD's that worked.

In another embodiment hard drives and other storage devices could use error correction algorithms similar to those used on CD's to avoid problems with corrupt files viruses, and hacks. It could check back to what the data should be and if necessary restore the data similar to how on a CD the reader recreates scratched data. This is different to antivirus programs which create a checksum of files and may in some cases by knowing a virus be able to undo its damage. Here the original information is encoded elsewhere, even making complete backup copies if space allows. More critical parts may have more error correction. Often there would be enough room because a given file may leave empty space in a cluster or file section on a hard drive. An additional tag on a file with error corrections on it might often only fill some of this empty space, and can indeed to be tailored to do this.

According to an embodiment there is a problem with electronic locking of cars because someone with a scanner can record the owner's unlock signal and then use it to unlock and possibly steal the car. According to the inventive concept the signalling means in this case send a signal to the car, which sends a signal back randomised or encoded in some way, but preferably different each time it sends it.

The signalling means receives this code and authenticates it for example by checking whether it is generated by an allowed algorithm even though it may have a random seed or variable. It then sends out a reply specific to that signal which opens the car or whatever device is being used. Someone intercepting the signal cannot use it because they don't know the algorithms and so cannot work out the right reply later on. Since the signal changes over time and as before multiple algorithms can be used recording even large numbers of them may not help.

Of course this system is not restricted to cars or any kind of alarm or protective system. It represents all applications involving a signalling means between two icons, to exchange data so that interception doesn't help to subvert the transmission. This might equally well be applied in transmitting all kinds of encrypted messages, and all other uses involving sending a signal.

In an embodiment devices are often used where PIN numbers and access codes are to be inputted. The problem is this can be observed and from the movements of the user the code can be inferred. To solve this, the positions of the numbers and symbols can be mutated.

The numbers can be shown by a display screen on which touching portions acts like buttons, or there can be standard buttons with display means showing what the button is for. Changing the positions of these numbers means a user has to look for a unique pattern of numbers whenever they use it. An observer has no way of correlating the user's movements to a code and so he cannot guess the password.

In an embodiment a storage device has a means to alter its data and this alteration can be read as extra information, protections against unauthorised use and other applications. Dots on the surface for example may change colour with laser heat on a CD or may burn away exposing other icons to be read underneath. Recording these changes a CD or optical device may determine the medium is genuine whereas a copy may not mutate in the predetermined way it should. Also the mutations may be read as additional information or data.

In an embodiment the storage medium such as a CD for example may be altered by an agent, such as air, light, chemicals, or heat and this sets a chemical reaction in train that alters the information to other data, or removes even many layers to expose other information underneath. Some lower areas may raise up or higher parts go lower in this change, or the angle of reflection may change to send a signal to other detectors or to not be picked up.

In an embodiment hardware circuits can also be designed to mutate to evade hackers, viruses, etc. In my patent application WO9910766 there was disclosed a circuit array that could be modified, to run programs for example and change itself in real time if needed. Some other aspects of the inventive principle of a mutatable changeable hardware circuit were also disclosed in my patent application WO02054378. In this case it was preferably for the purpose of reprogramming chips to optimally run different programs, but the alterations to evade hacking represent the same inventive principle.

According to another invention software can be written to be easier to understand and debug by making comparisons to known mechanical devices.

Preferably these devices include cogs, levers, hydraulic systems and electronic circuitry.

Preferably these software sections can be analysed to see if they perform this known function analogy correctly and the extent of the parameters of this operation. If they work correctly throughout these parameters then one moves on to the next section and checks it under the same criteria. Afterwards the software may be compiled and altered as desired.

Software today has a major problem in that being so complex it is easy to lose sight of how it works and to make mistakes or bugs that are hard to find. By contrast this rarely happens with mechanical devices because each part is checked, we know what it can do and what it can connect with. If the total assembly doesn't function correctly we can normally find the faulty or overloaded part or section and replace or redesign it.

This same analogy doesn't apply well to software today. While each code icon could be considered to be cog like in its operation many sections in principle should resemble machinery in their operation. For example one part may make copies of files or transfer files for one place to another. These parts for example could be tested separately to see what they can do regardless of the rest of the software, somewhat like testing a cog.

Once we know what it can do we move to another definable section as a mechanical operation and see all the things that can do, and when all this is done we can see if the parts fit together to make a smooth operation or the failures should be easy to see from knowing that some parts don't connect to each other outside certain parameters.

According to another invention there is a means for controlling cursors and inputs on a computer.

Preferably this comprises a means to translate individual finger movements including side to side, up and down and all other movements into movements of icons in a computer program.

Preferably these movements can include writing and tracing out symbols.

In a preferred embodiment computer mice have the disadvantage that when one has to input words one usually has to use the keyboard. It would be desirable then to have a means to easily trace out keyboard inputs with a mouse or input pad like a PDA, mobile phone, or touchpad on laptops.

Preferably this would involve a combination of a handheld device such as a mouse or PDA and a section on it like touch pads where moving a finger around on it translates to cursor and other inputs.

In an embodiment there are mouse buttons which are also like touch pads like on laptops though they can also register in and out motions as well as tilting. They can be any kind of button or joystick like device suitable for guiding the fingers according to the inventive concept.

One can on these touch pads trace out symbols such as letters, and have a handwriting like analysis program in the computer translate these into actions such as commands, displaying text, executing macros, and so on.

The fingers in this way are capable of tracing letters very quickly, and one can trace out for example letters on top of each other to form words. Also one can write in longhand with a finger like this, by tracing a letter then either breaking for the next letter or curving across the pad to the left to start another letter.

In this way one can in effect write longhand except the letters are on top of each other not one after each other like in normal writing. By pressing and tilting the pad one can add other effects as desired. The best way to see this is to try this while holding the mouse as an example. The finger next to the thumb is preferably used. If the reader tries to trace out letters on the mouse button he can do so surprisingly easily and quickly and these would be analysed and executed by the computer.

In same way one can do this with the fingers in any input device, preferably PDA's, mobile phones, and laptops.

In an embodiment laptop computers often have a touch pad in the centre. Putting it in a front corner can make it much more easily accessible for all kinds of input with the fingers, especially the ones described here.

In an embodiment keyboards, mice, and other input devices can be velocity sensitive similar to piano keys. This speed or hardness of hitting a key can translate to a macro command such as capitalisation of a letter, emoticons, and so on. Also they could be tilted for certain commands, eve moved from side to side or forward and backward.

Preferably this and other inputs like writing with any input device can also be used with feedback from the recording device. Typically programs make occasional errors in interpreting handwriting, voice recognition, and analogue inputs of all other kinds.

Preferably then the programs that attempt to recognize these inputs should feed back graphically, by sound and in all other known ways, where errors were made and how the input could be improved in future to reduce error.

For example the mouse system described here is handwriting with letters on top of each other and the computer learns to recognize this, perhaps by the user inputting a lot of samples in the computer to recognize the style, and by adapting handwriting program known in the art. Of course this equally applies to voice and other recognition.

It is not intended to be limited to the inventions and applications described here but can be applied to any situation where devices make errors in interpreting instructions and by providing feedback on their decision processes we can guide them to avoid errors and also avoid doing things the interpreting means has problems with.

As this progresses the user inputs information the computer fails to recognize properly. We then indicate to the interpreting means it has made mistakes.

It can then perhaps display multiple guesses of the data and show in perhaps a graphical way how it arrived at its conclusions. In an example only if this is for voice recognition it may show how the words said sounded similar to other words and it became confused. To fix this the operator might practise saying the words and in a graphical feedback see how their attempts compare to the boundaries of what the computer considers that word should sound like. If they stray outside these boundaries they see their mistake and so adapt to the computer rather than the computer adapting to them. Of course we already adapt to voice recognition but this inventive step gives the feedback to do it quickly and accurately.

In the case of handwriting recognition it might display a word like cat in a test so that one sees representations of shapes, with an envelope around the writing style that the program believes is ideal that it would still accept the input as cat.

The user then would see how he could vary writing cat so the computer would understand it and perhaps see how his input might sometimes fall outside those error ranges, and perhaps fell into the parameters of other possible words. By seeing that the boundary between one word and another is very close they learn to take more care not to cross it.

In an embodiment of the inventive concept interacting with Artificial Intelligence can use the same feedback. The program or hardware indicates graphically how the instructions or its environment falls outside of the envelope of what it can understand. Instead of having to reprogram it then the environment itself can be adjusted or tailored to the AI.

Like the old saying “nature or nurture” the program works better by altering its environment and our actions according to what it can do and understand, instead of it having to learn things that by their nature are difficult. In some embodiments we might instruct it to avoid some situations or to ask for additional feedback.

Preferably this feedback should include a scoring facility showing the users how close they got to making errors also whether they are improving or getting worse.

Preferably this recognition would also include options for computers to have joined words in its database of recognised words. In the example of words that are not sufficiently separated then the program could attempt to resolve “canhave” as “can have” because joined words in its database would be listed as other words, with the instruction to separate them. Instead then of trying to train the program to recognise words too close together we teach it to recognise them as “meta words”. “Canhave” then would be a metaword that meant “can have”.

According to another invention there are often major problems in using money electronically in places such as the Internet and EFTPOS electronic shopping in stores. One major difference is that we tend to have currency notes but there are for example no twenty dollar electronic notes.

There is provided a numerical means to symbolize given amounts of money and other items of value or utility.

Preferably these numerical means can act as a symbol for value and can be tendered as money.

Preferably they represent a unique designation or number that is recorded as representing a key or check to collect a certain amount of money or goods.

Preferably this numerical means uses known encryption methods to make it difficult for this numerical means to be thwarted.

In a preferred embodiment it is well known that certain large numbers are difficult to break down into factors and other forms of analysis. Indeed much of modern encryption such as RSA depends on this.

It is an objective to create certain numbers that are difficult to analyse and to use these numbers as symbols of value or utility. On receipt of the number and a related number such as a factor of this number or a PIN a given amount of money is transferred or preferred actions taken.

In a preferred embodiment there would be a banking or similar establishment to create negotiable numbers to use as money. This number would be hard to factorize and when one paid for this number minus a fee perhaps, one would receive this number, its factors and other suitable safeguards such as PIN numbers. It would also be registered as being sold as a valid unit of value. If someone checked on the number they could contact the issuing authority and quote the number, and it could be confirmed as being worth say $20. Without the factors though, in this example it couldn't be used. There would be no need to hide the number, just its factors and a PIN.

One would take this to a shop and decide perhaps to buy something for $15. The shopkeeper would take this number and check it perhaps electronically with the banking means and confirm it is a valid number representing a particular amount of money. The banking means in effect agrees to pay the shopkeeper $20 perhaps minus a fee like credit cards have, if he can supply the PIN, the factors, and other desirable inputs with the number. The buyer gives this information and the shopkeeper generates if desired, change in the same way, giving a number representing $5 with factors and a PIN.

In one embodiment the factors are given in encrypted form so only the user can read them by arrangement with the banking means. For example the customer may have an account number that acts as a decoder for the factors. When he desires to acquire a currency number for change in this case, the banking means encrypts the factors and the acquirer can decode it with their PIN or whatever secret numbers desired. Otherwise the shopkeeper could use the factors in the change to steal and resell the exampled $5.

Preferably this can also take place online where people can deposit money electronically and receive change and new numbers in places such as banks and all other places of commerce.

Preferably someone can use these as safe storage for funds by in effect placing these numbers in a safe place for future use. For example by encrypting the factors and remembering the unlock code the numbers would be safe against theft and be like being in a safe.

Preferably these numbers can also be used as a key or identifier for future actions such as opening safes and other sealed materials.

In one embodiment these numbers are themselves account numbers, credit card numbers, smart card numbers and so on. The factors in this case would be either encoded in the card or held by the banking means.

According to another aspect of this invention there is provided a means to use mobile phones and PDA's and other portable messaging means to send and receive financial and other information.

Preferably these messaging means have the ability to send and receive infra red signals or for messages to be typed in and replies observed.

According to a preferred embodiment mobile phones and PDA's are very common through the population but there are still many times where information is hard to find.

To solve this there can be spread in many places symbols like phone numbers that can be dialled to receive text messaging or voice responses. For example at a bus stop there can be numbers relating to particular buses which when inputted into a PDA or mobile phone give that bus timetable.

According to another aspect of the invention one could be looking for a map of a store or area and there could be a connector that one can plug a portable device like a PDA, laptop, or mobile phone into, or the device can interact with them by radio or infra red radiation. This can supply maps and other information, and by interacting with it such as by moving arrows different parts can be shown.

Any object then in principle could come with a kind of mobile phone number designator, or any kind of code even a web address easily loaded into a device to get directions, ask information, and any other kind of interaction.

According to another aspect of the invention this can also occur with other mobile messaging devices.

For example instead of having to pay somebody, one could transfer funds from one mobile accessory to another or to a fixed electronic device.

For example to pay $100 to another device one could log onto one's banking means and request this money be allocated to be paid according to a certain number or numbers and a PIN. The money may preferably then be allocated to a separate location such as a separate folder in the banking means perhaps analogous to a small separate account with its own number identifier. On giving this number to another user, perhaps with the aforesaid mobile messaging means they upload this number to identify the money location, and then they are provided other identifiers such as a PIN or factors of that number to take ownership of that folder, account or just the money.

In this way money and other transactions can occur without many of the current formal procedures. The folder represents a kind of temporary account with a variable ownership. If stolen only the contents of the can be taken, not from other accounts.

In an embodiment a folder account can be connected to ATM cards and contain money or credit of a given amount. It can be replenished automatically by some rules or by the owner. When checking this in a banking means, it may list these folders and their balances. A transaction can then be done by transferring the folder to someone else.

In an embodiment these folders act as a buffer against theft. A personal account resides in a folder in which a lesser amount of money is deposited. Only a certain amount may perhaps be withdrawn in a given time and other known security precautions ca be applications of this inventive concept. If the details are stolen only the folder can be lost or its contents.

According to another aspect of this invention there is a means to synchronise money transfers for a common goal.

Preferably this involves the tendering of a proposal to request money or other services for such as a loan, or to underwrite perhaps insurance or business proposals.

Preferably there are subscribers to this service where people or institutions are willing to receive requests to invest their money, even in small amounts.

According to a preferred embodiment there is a service to raise money for business proposals and loans. The service needs to raise a given amount of money say $100,000 as it believes it can loan or invest this in a good proposal. It sends out messages to subscribers perhaps by email or instant messaging outlining the terms and its commission in the matter.

There may be only a few investors though preferably there would be large numbers, each of which may only invest a small amount of money such as $100.

On receiving this request the subscriber may have automated instructions on what to accept or they may decide to accept or reject the proposal.

If they accept they forward a number representing a given amount of money to the collection means, which can redeem these numbers as already described for money. Otherwise they can pay by more traditional means.

Additionally there can be encryption means to send PINS, passwords, and factors needed to activate this number to redeem for money or services.

In this way even a small entity can act as a bank or insurance even securities company, and the subscribers get better interest. If desired this can be underwritten by a larger company to reduce the risks such as by demanding unemployment, fire and other forms of insurance to the receivers of the moneys, loan or services.

In another preferred embodiment services can be accumulated this way instead of money such as tradesman work, advice, information, and so on to be collated and sold with varying proportions going to the subscribers. Thus the system can work as a team enterprise provided any kind of service for a fee by drawing directly on its members for various parts.

According to another invention there is provided a means for additional information in sensory devices such as X ray machines.

Preferably these include an emitting means capable of irradiating selected parts of a subject from various directions, of varying frequencies and by varying motions relative to the subject.

Preferably these sections take the form of slices each from a preferably different direction so as to give data to create a three dimensional representation of the subject without using dangerous amounts of the irradiating means such as X Rays.

In a preferred embodiment the X ray emitter is designed to emit narrow wide bursts of X Rays from different directions, so that parts of the subject might receive one burst of radiation from one direction, but not more from other bursts in other directions.

Preferably this would involve different bearings of the compass but all preferably substantially horizontal to avoid the subject receiving more than one emission in any given area. This is to avoid an overdose in radiation.

Preferably these angles would be such as to maximize the ability to reconstruct 3D photographs of the subject which may be a living thing, or an object. In this example there would be 1 degree differences in a compass bearing between each emission by example only.

Preferably these slices of images would be taken either very quickly one after the other with one or more emitters and cameras, or they could be taken substantially simultaneously by many cameras and emitters.

In one preferred embodiment there would be a camera and emitter mounted on a spiral attachment, and the subject is inside it. The emitting and recording means would spiral down spinning at different angles and at certain points take images from different angles so as to take slices of images of the target.

This information is then collated to make a 3 dimensional image of the subject.

According to another invention there is provided a means to create a pattern of electromagnetic radiation or sound waves which acts as a barrier or triggering device.

Preferably this radiation is in the form of laser light of a predetermined frequency. Preferably this light is reflected or refracted between objects so as to form a zigzagging motion which in effect creates a zone through which objects are unlikely to get through without hitting a beam.

Preferably the rays pass quite close to each other so as to minimize the chance of an object passing through the barrier without being struck by a beam.

Preferably the beam is of a strong intensity so as to damage or preferably destroy an object attempting to pass through the barrier, or the beam may be interrupted so as to notify a monitoring means of the intrusion.

In a preferred embodiment there is a production of coherent light of high intensity to be narrow and focused. This light beam is to ricochet between two vertical pillars of reflective material so as to present as few gaps as possible, starting at the top and zigzagging to the bottom, where it can be directed to the top again or back into a laser for recharging. Because the beam can be tightly focused and the beam loses little strength by being reflected if an object tries to go through the barrier they receive the full force of the beam as if it has been aimed at it.

In an embodiment the screen is of a predetermined size and shape, a square meter as an example. The beam is focused to be perhaps a hundredth of a millimetre in width and bounces between the reflective pillars, and then is fed back into the laser to be strengthened.

Even though a square meter is covered here any intruder receives the full strength of the laser. It has the effect then of a large area acting like a force field, with each point in the field equivalent in strength to the cross sectional force of the laser.

Applications would preferably be to stop small objects such as bullets, meteors around a spacecraft, and other intrusive objects.

It could also be used as a barrier device to keep people or animals enclosed, as in trying to get out they would be burned by the laser. In their experience it would act much like a force field seen in movies where all parts of the field would be damaging.

Preferably the pillars would be of all possible shapes and orientations, and be constructed so as to minimize their being struck so as to disrupt the beam. For example there could be many sections added together which could be assembled like a fence, each with its own beam, or one beam travelling to all sections.

The pillar would preferably have the reflective pillar very thin to minimize it being struck and this pillar could perhaps vibrate and move so as to make it difficult to hit.

In another embodiment barriers could be erected to control the movement of pests such as insects.

Preferably this would control the spread of locusts.

In an embodiment lasers and other waves are directed onto undesirable objects such as rodents and locusts. This may be done by a targeting means which establishes their position and directs the laser to shine on them deterring or damaging them.

Preferably this can also be done by a predetermined pattern which creates a lattice of laser sweeps which covers an area sufficiently to deter the pests.

According to another invention there is provided a means to establish root shaped structures in data so as to compile how data points to a given location.

Preferably this would resemble the roots of a tree which is distinguished from the branches of a tree like in a normal search.

In an embodiment when we look up terms in a search engine it tells us how to get to data of interest but it doesn't tell as what web sites link to where we want to go. For example if we are interested in a web site, if we could look up lists of web sites that linked to our preferred web site we could probably find more useful information.

A search engine should do this by for example putting the web address we are interested in into the engine, and it would show us which other web sites point to it. Normally though it cannot because it can't read what the links point at when it searches. For example if it searched for links to http://www.business.com it would find very few, even though many sites may mention it and even link to it.

It would be preferable then to search perhaps with bots for this information by clicking on links of sites and recording where they go to, so one can search down the roots of the analysis tree though hyperlinks in reverse. Otherwise search agents may devise ways to read the links when they search a page.

In the same way analysing a database would determine what parts found our search terms to be of interest and it is likely that those areas would contain desirable correlations. We can also follow these root structures further to see what links to them at deeper levels and so on.

One would also find and analyse other structures such as rings of links where pieces of data refer to and link to the next and so on back to the beginning. This would be useful to see if information is really supported or is only using other parts of the ring to substantiate it in a kind of circular reasoning.

All forms of connectivity other than the normal branch structures known to the art are contemplated for this analysis.

Applications for this would include the Internet but also all database structures.

Also there is a means to use algorithms to alter the size of data in different places to analyse it.

Preferably these data sections are in a grid or regular or irregular shape, and this information represents the mapping of data, such as a terrain but it can also be any data file or signal such as photos, text, sounds, video, etc. This grid can also be temporal in the form of a moving window on the data, even of varying size. Windows like this as an example are used in many compression programs.

Preferably these algorithms include compression algorithms such as LZW and JPEG like lossy compression. There are of course many other known formats of compression and encryption known to the art which can also be used.

Different sections are compressed or interacted with the desired algorithms and it is noted that some sections compress or grow more than others. These changes may be associated with terrain changes and so these algorithms can be used to search and analyse data and terrain for various desirable objectives.

For example smooth ground on a map might compress differently to rocky ground and so variations in data sizes in different parts of the grid can be plotted as characteristics of the ground being mapped.

In an embodiment some files such as for example a song when compressed might shrink to a greater or lesser percentage in different parts of the song. Mapping these percentages would create an identifier unique to that song, movie, data, etc. which could be represented as a graph of a percentage of compression versus time into the file while playing it, or a percentage of the file played. For example 21% into the file it may compress 80% and so this represents an identifier or fingerprint of that data. With enough points like this a file can be identified even if substantially changed.

In an embodiment the example song to be fingerprinted is broken up into regular or irregular sections, such as 100 kilobyte pieces, and it is noted how small each section becomes under a compression algorithm. In a variation it could be broken into for example 10 seconds of playing time pieces and each part compressed.

Some files could be made harder to pirate by making them less compressible. Data that is hard to compress but doesn't affect sound quality can be added to sound and movie files, such as WAV files. When someone tries to compress them for example with DIVX or MP3 formats the extra information doesn't compress well and the file ends up being far larger than it should be. One way to get around this would be to play a song for example and resample it, but that is a lot more trouble. In some embodiments the extra data is less compressible even after doing this.

In an embodiment noise and defects are added to files which are only filtered out by an authorised player. This interference can be according to algorithms with a random seed and variables so an authorised player can filter it out, but a hacker could never work out the entire algorithm.

Preferably each file, for example to be downloaded from a web site by the owners, would have a different noise and interference in it, with a coded identifier in it that was the key to removing the noise. This of course could be well hidden in ways the authorised software knows how to find.

In an embodiment this noise and distortion could have in the file a serial number preferably unique to it, which the player reads but cannot by itself decode. To get rid of the distortion it reads the identifier and generates a serial number from it. This serial number needs a unique unlock code as a response before the player can know how to fix the file. Ideally the serial number would be partially random as previous disclosed, so the unlock key would only work on one computer.

Of course the manufacturer only releases the unlock code with proof of purchase of the song, video, software, etc.

In an embodiment a satellite photo is divided into sections perhaps like a grid, and some parts may compress indicating buried regular patterns such as archaeological ruins. They may also pick up faults, kinds of vegetation, and even mineral deposits.

A moving window may collect a desired number of pixels in perhaps a square and the changes in the algorithms monitored as the square moves around, till the objective change in data size is found.

In an embodiment data in a database such as for example the Internet can be compressed and the dictionaries and parameters can be analysed. Web pages as an example can be compressed and the compression dictionary lists frequently occurring words or icons, and these can be recorded in a database. These can be linked with other sites with similar or relevant associations with frequently occurring icons in search engines and other classifying means.

Instead then of just looking at associations of data it is possible to look at and compare compressed data attributes.

According to another invention there is provided a means to assist robots and artificial intelligence programs to do certain tasks.

While modern computers are capable of many tasks they are much less good at some aspects and so tend to rely on human intervention.

It is an objective of this invention to provide assistance for these programs from humans in a remote capacity, preferably over networks and the Internet.

It is also a further objective to structure the help they need in a form so that humans can use their judgment by seeing abstract problems sometimes in the forms of games and puzzles as well as by actually receiving direct data on the problem.

Preferably this information would be delivered to humans by computer.

Preferably it would be structured so people didn't know what it was for, and so that a plurality of people may sometimes do the same task to ensure the solution is correct.

In the preferred embodiment there would be a network in which people could log into to work at as jobs paid or unpaid.

On these networks they would be presented with puzzles that symbolize problems computers and robots need to solve, such as moving or walking, adjusting industrial robots to new tasks, and so on.

People solve these problems and the results are transmitted to the programs and redone if needed. In return they may be paid for this work.

According to another invention there is provided a means to cool objects. It is also an object of this invention to make this occur without needing normal refrigeration and power.

Preferably this would be employed on small objects like drink cans and cold compresses but the principles can also be used for any cooling requirement.

In my second patent application WO0025429 I described an invention of a sponge like material in a deformable container with a reduced atmospheric pressure. This can be used in many applications as described there, and such as tires, artificial organs such as hearts and so on. It can also be used to reduce sound. A container with a partial vacuum and foam in this embodiment of the inventive principle disclosed in my patent application WO0025429 tends to let less sound through and so can be used as a cheap way to reduce noise and other sounds. For example containers with foam and vacuums inside could be stacked as insulators to reduce sound and heat loss.

In this preferred embodiment of that invention there is provided a deformable container which can be placed around or on something that is needed to be cooled.

Preferably the object would be a can of drink and the container would be deformable into a shape to wrap around the can, perhaps in the shape of an insulating holder which is known and available on the market. Of course this is in no way limited to cans but any object at all can be cooled in this way.

Inside there is reduced air pressure and foam which acts against the vacuum to prevent the collapse of the container. Inside would also be a container of a suitable liquid which when released would become a gas because of the low pressure inside. Refrigeration fluids would be a good example.

Also there are provided means to open the interior container as desired which will then vaporize and thereby create a cooling effect on the container, which can be transferred to the drink or anywhere as desired.

Ideally the interior container may have a sharp section, which when pressed through the exterior container punctures it releasing the fluid.

As a preferred embodiment the container can be opened and the gas dissipated, another satchel placed inside or there may be additional satchels of coolant already in there.

The container can then be compressed to remove a desirable amount of air from it, and then sealed. The foam will then expand and create another partial vacuum inside, which can deliver another cooling action when the interior satchel is punctured.

Other applications could include Eskies and food storage on for example trips, where it is impracticable to carry refrigeration. The foam container in some cases may be very large and to crush the air out of it people may sit on it, or drive a car onto it. Coolant may also in this case be poured into the container so when the weight is released it evaporates as before.

The inventive principle is then to have a cooling effect with deformable containers of all sizes and shapes that have a resilient foam like substance in the interior, a partial vacuum and a refrigerant substance. Preferably also the outer surface would be an insulator to keep it cold longer. It should also have a place to put objects to cool them.

As long as the object to be cooled is contained so little heat can get in, the cooling effect could last a long time. Thus it may also be suitable in third world countries to act as a refrigerator. In this case the emphasis would be in providing cheap coolant to work in the container, such as alcohol for example.

An embodiment would then be an area inside the container or where the container can wrap securely around so objects desired to be kept cold can be placed there, instead of having to be put in the container with the coolant. At times it may be useful to open the container and release the coolant, and replace it to restore functionality.

According to another aspect of the invention the foam can be replaced or augmented by springs and other similar devices. The container can be deformed as before with the coolant inside, and the spring causes it to increase in size. Instead of a spring an explosive or chemical reaction can be used to increase the size, though the heat would be kept separate from the cooling means.

According to another aspect of the invention a spring could be replaced by people or objects pulling from outside, to create the vacuum. In third world countries this could be done by people or animals pulling to expand a container with a way to brace it from collapsing in size again when they stop pulling.

Inside could be material or food to be kept cool, which can be accessed by opening the container or by a separate compartment with a separate door to the outside. When the inside became too warm the device could be recharged by releasing the braches preventing it from contracting, compressing it and allowing heat to dissipate by opening the insulation. Then the cycle is repeated.

Preferably this action can also be automated with levers, pulleys and cogs.

According to another invention there is provided a means to simulate movement in condoms.

One of the great tragedies of the AIDS epidemic is that much could be averted if people wore condoms. However the major problem with condoms is that they reduce the sensations and pleasure in sex, and consequently they are not used and disease sometimes results.

It is an objective of this invention to create a condom and penile sleeve to simulate feeling during intercourse.

The basic problem of course is that while there is motion outside the condom there is no motion inside it as the condom or sleeve material doesn't move relative to the skin.

It is an object of this invention to provide appendages to the inside of condoms, and also to the inside of a sleeve to be worn inside a condom.

Preferably these appendages move in preferred directions according to a squeezing pressure.

Preferably they also move according to other movements outside the condom.

In a preferred embodiment there are icons which protrude outside the condom or sleeve and inside it. As there is motion outside the condom this tends to push the outside icon and therefore it would tend to push the part of the icon that extends inside the condom in another direction, preferably opposite. The outside motion is then translated into a feeling of motion inside, and the squeezing also into sensations and feelings of motion. These can compensate for the loss of normal sensation and overcome the main reasons for not using condom protection against disease.

Preferably there are other icons inside the condom that when squeezed or moved alter their length and position.

Preferably these can be long or short, hair or fur like, and some designed to slide differently with different pressures.

Preferably some icons can be separated from the membrane. The inventive concept then is to mimic the feelings of movement by transferring motions from icons that protrude outside to icons on the inside.

According to another invention there is provided a means to reduce radiation in mobile phones.

According to another aspect of the invention there is a record and playback means and a transmitting means, which are connected by a weaker transmission means.

Preferably the transmission means consists of a similar transmitter to a mobile phone, walkie talkie, and other communication devices.

Preferably the recording and playback means consists of a microphone and speaker substantially similar to those used on mobile phones and similar devices.

Preferably these are connected by a weaker signal, sufficient to transfer the spoken signal to the transmitting means, and to relay incoming signals to the speaker.

Preferably these can use radio waves, lasers, or sound waves such as ultrasound. The transmitter would be preferably worn on the belt, in a purse, or another convenient place. It may even be active over a short distance such as inside a home or office, throughout a car, or other limited distances.

Preferably the handset should then be much smaller and give out less radiation. It might for example be in the shape of a pen, a flat piece like a comb or be foldable. It can be charged in many ways, such as by being connected to the transmitter for a time.

Buttons may preferably be placed along the shaft in the case of a pen shape. It may also consist of an earpiece and separate microphone such as worn like a necklace or near the voice box, even to fit inside the mouth perhaps over teeth like a small mouth guard though preferably just over a few teeth on the side.

In another preferred embodiment there is a playing and recording means designed to be small and easily hidden, and to act like a mobile phone and possibly a GPS positional locator. It could be worn and if something happens to the user they can be contacted or located.

Preferably it can be covered deceptively, coming in innocuous shapes such as lipstick cases, jewellery, on a keychain, even inside clothing or a shoe.

Preferably it can be activated remotely or it can be activated by the wearer, or it can automatically work after a certain time has elapsed.

Preferably it is capable of sending and receiving but it may also be capable only of simple text messaging, or of only sending a voice message and receiving for example flashing lights to indicate a message has been received.

Preferably text messaging may be done by tapping to give a Morse code like ability to form letters, or it may have a miniature keyboard.

Preferably it can recharge itself by a small solar panel or can be powered by external means such as squeezing or blowing through it generating power.

According to another invention there are means to control computers and related devices.

They refer to the use of external controllers in computer related devices. For example laptops, pocket calculators, etc though larger devices and parts of networks, Internet, etc are also part of the incentive concept.

In some devices it may be desirable to make it easier to input and extract data. One way is to use a projector like mechanism to create a viewable area in which data may also be inputted.

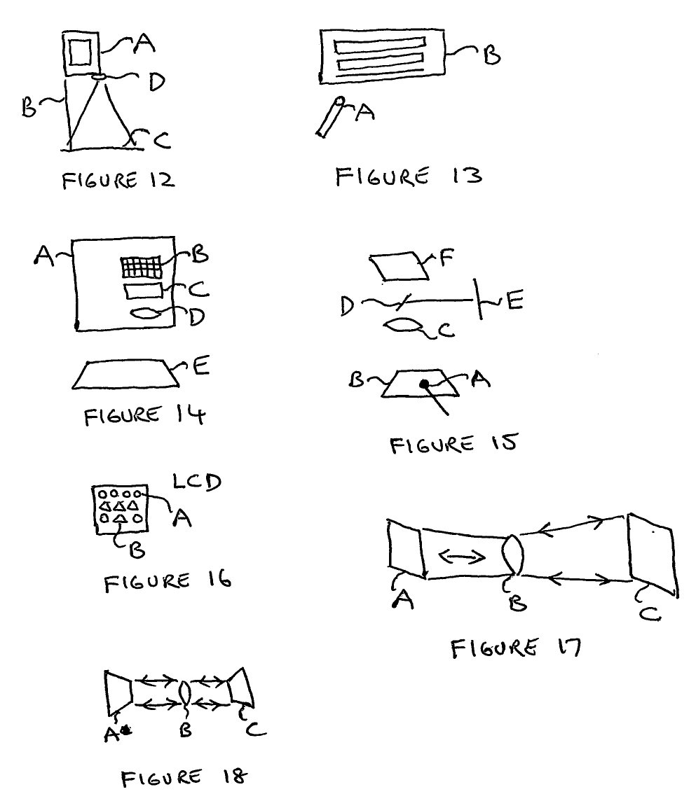

In this example a projector like device in a small computer like a Palm Pilot projects an image onto a surface as in FIG. 12. This may be a special surface or even a piece of paper. A is the computer, B is the stand, C is the surface to project an image on, and D is the projector. In the picture displayed there may be information such as movies, web pages, email, even a keyboard outline.

A device may further be used to interact with this image.

If the image is projected onto a panel device pressing or for example adding light to sections may activate operations, for example like pressing keys on a keyboard, activating hyperlinks, mouse movements, etc.

In another variation images are projected onto any other surface but for example plain paper.

A device perhaps like a pen, mouse, pointing instrument may indicate a part of the projected image. This selection can then be read by the computer like device as an input.

For example FIG. 13. This could be an image of a keyboard B. The pen like device has a tip A which shines a distinctive for example light when activated or it could be a radio like beacon, any way of indicating its position.

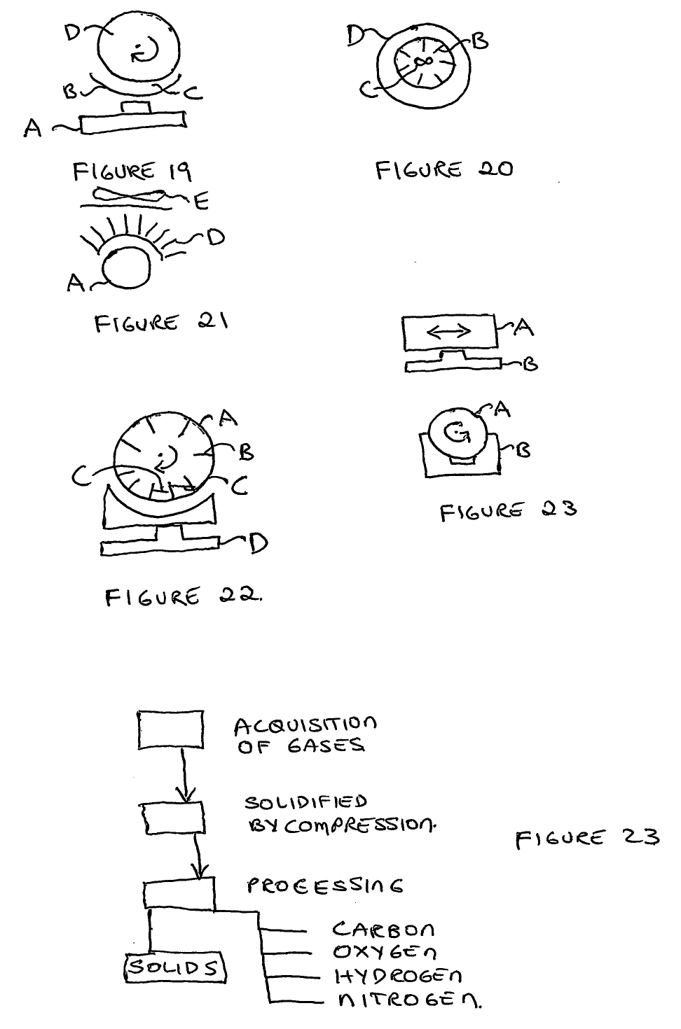

In FIG. 14 the LCD B can create an image which is projected onto E. The CCD like array C allows the LCD image to pass through it. A is the computer device.

Of course these parts are interchangeable and can be in any order. For example the LCD and CCD can be curved and can use other mirrors and lenses and be in different orders.

The CCD's on their surface might be much sparser than the LCD pixels.

In another variation light or other from below may be rerouted so that “light” need not lass through both plates for example with a one way mirror.

When the pointer as an example described earlier is in a portion of the image referring to an input for example a hyperlink it may be activated by like a mouse click to emit for example a light colour that goes through the lens and is received by the CCD and interpreted as an input.

In FIG. 15 when A shines the CCD E receives an input associated with that part of the screen image. B is the viewing surface. C is a lens array. D is a one way mirror means. F is an emitting means here a LCD.

In this way someone could activate hyperlinks, type messages, etc.

The stand involved might be of solid even separate construction or it could be a fold out part of the computer.

The computer could be integrated with the CCD and LCD or it may be separate and send and receive signals to and from it.

Consider as an example an LCD screen interspersed with CCD's so it can receive and emit a message as shown in FIG. 16. A are LCD emitters and B are CCD receptors.

When viewed through a lens or any other focussing mechanism (lens in this whole application refers to all possible focussing mechanisms and light refers to all transmittable data for example by sound, radio, waves, etc.) the array can emit an image and receive information about how that image alters.

This could be a light indicating a keystroke or it could be more complex. For example it may emit an image which varies so that information on the surface is enhanced in viewing.

In the case of detecting intruders it might emit varying images and record differences in images received so these differences may help indicate colours, size, etc. of the intruder.

In FIG. 17 extending this principle information can be exchanged as shown, A and C are LCD/CCD arrays that transmit and receive data to each other, B is a focussing means.

In FIG. 18 A, B, and C are similar arrays, Of course LCD refers to any radiation emitting devices and pixels as part of these and CCD as any kind of radiation receiving devices, pixels as parts of it.

In another example light projected onto a scene may cause shadows, etc. The CCD array gives feedback to adjust brightness and colours projected onto any surface.

This might take the form of headlight like devices on a vehicle altering brightness and colour through feedback as it perceives the level of visibility it is giving. If objects are brown in parts for example it might direct more brown there or avoid brown to make objects less visible.

Many other lenses, mirrors, curved or otherwise can be employed with these devices. For example it may be desirable to place lenses over some or all pixels, whether separate lenses or ones that cover many pixels.

One example of an application would be a viewing screen that also acts as a camera.

These devices can also be linked with devices disclosed in my previous patent applications on 3D systems, where LCD and CCD devices can send and receive 3D images.

Another invention relates to the field of cooling. These involve as examples the making of cooling apparatus for devices such as computer chips.

These have a problem in their current state in that as chips (CPU's for example) get hotter it is harder for fans to keep them cool. This is because the metal parts of the fan are limited in their speed to dissipate heat to where the fan is through the metal close to the chips.

In FIG. 19 D is a piece of material that may be solid, or perhaps inside has cooling features such as fans, Peltier devices, etc. As D moves or rotates the section B is constantly or intermittently put in contact with cooler parts of A while the hotter parts move away to cool. A is an electronic device or anything to be cooled. C may contain a fluid.

In this way the heat is more quickly removed. In some variations D may be enclosed, perhaps with a heat conveying fluid or gas.

Inside D may look like FIG. 20. B may be fin like devices that convey heat to fan like devices at C. Also in FIG. 21 above A (before referred to as D in FIG. 20) may be a similar apparatus.

Above A here are cooling fins D and perhaps fans at various positions like E, even other devices such as Peltiers.

In another variation fluid and other may be moved inside A to present cooler material to contact with the hotter parts whatever they may be.

In FIG. 22 C is a fluid like material that is moved for example by vanes B away from the heat source D so cooler material falls down to replace it, somewhat like a paddle wheel.

In FIG. 23 A moves backward and forward or on a ring over the heat source B.

In an embodiment, parts of some guns overheat and these devices can be used. Also air conditioners and all other structures that require the transfer of heat can employ these methods.

According to another invention there is a means to stop objects sliding on smooth surface.

Preferably these means would be employed on surfaces such as in cars, trucks and vans though it may be desirable on any surface.

Preferably this has a series of icons which are on the surface, and which can be somewhat flattened when objects are placed on them.

Preferably these objects also resist being deformed when objects push on them from the side.

In a preferred embodiment one major problem with freight in vans is that boxes slide around and can get damaged. It would be good to have an easy way to secure them without having to tie them down for example.

An embodiment would be a mat in which bubbles of material are pushed upwards, preferably hollow. These bubbles which can be any shape might look something like the surface of an egg carton. Like an egg carton surface if you place heavy boxes on them they would tend to flatten the bumps, but preferably here the icons would tend to rebound when the heavy objects were removed. Also like the egg carton analogy when some icons are flattened the ones next to the boxes are still upright and they would tend to resist movement from the side and so hold the objects in place. Of course if the movement is strong enough they would also buckle but depending on the preferred manufacturing process these can be rigid enough from the side but still be able to be pressed flat under an object.

In an embodiment icons like car aerials can be used, in the sense that parts may telescope out, preferably through some kind of springiness and shorten when an object is on top. There are many other designs apparent to someone skilled in the art which would have the properties of being deformable when objects are placed on them but resistant to sideways motion, and this can be used anywhere these properties are needed.

According to another invention there is a means to use a laser to read smaller features on optical and storage devices like Compact Discs and DVD's.

One of the problems in making these is that the laser has a resolution based on its wavelength and this makes a limit on the size of the features on a disc that can be read. It would be desirable to have a means to read these smaller features, not only on optical discs and devices but in all applications where an emitting means of a predetermined wavelength needs to read small features.

In the emitting means herein, using the laser in a CD as an example, if the laser beam is larger than the for examples bits, pumps, facets, whatever surface is being read then it might read part of one feature and part of another feature so there is confusion over what data is actually encoded on the surface. For example, this can be used in conjunction with the optical storage CD devices disclosed in the priority document of my patent application number WO9910766.

In the preferred embodiment the laser width can be of varying sizes and there can be multiple lasers perhaps at different positions and angles. Say for example the laser is shining on 2 small pits and one land and it receives back a signal as ⅓ of the energy sent out, but it doesn't know in what order the pits and land are.

By having also another laser with a larger width it can look over the same features and get a slightly different reflection and so infer by comparing the information from a plurality of beams of different lengths and widths or a beam with changing width the sequence of the pits. In effect then using a plurality of beams of different widths and shapes, pits for example can be read even though they may be smaller than the wavelength of the smallest laser used.

For example say the 2 pits and a land we don't know the order of are followed by perhaps a pit, which we know because when the laser moves the equivalent of one icon on the surface it gets still say ⅓ of the light reflected back, and so this tells us something more.

If another laser for example with a width of 4 pits and lands looks at the same sequence it gets a certain reading back. When another laser with say 4 and a quarter times the pit width looks it sees something slightly different as it is looking into part of the next pit or land but it can also straddle part of the pit or land before the 4 sequence.

Each difference in width may tell us something a single laser width couldn't know and by narrowing down the options in this way we can read and infer more about the surface than before.

In another example say the surface again has the imprint of two pits and a land but we don't know what order. As the disc moves the signal remains the same which would imply the sequence is repeating but we don't know what order it is.

A laser covering 4 icons wouldn't repeat though and by comparing the signal from both we narrow the possibilities, and with a laser of say 5 icon sizes we narrow it again. If there are still some ambiguous patterns we could simply say the ambiguous ones are presumed to be identical data and are written that way. We still have recovered more information smaller than the single laser could have done.

In another example say we think it is 0,1,1,0,1,1, . . . from the 3 width laser or any order of one zero and two ones repeated in the same way. The 4 width laser sees the first 3 and the 4^{th} as a 2/4 reflection so half are pits and half are bumps. 0,1,1,0 is possible but 1,1,0,1 is ruled out so it cannot be 1,1,0,1,1,0, . . . It also cannot be 1,0,1,1,0,1, . . . as that would be a ¾ reflection. So in this case 2 lasers larger than the icons found out what they were to some degree. Of course all widths of lasers can be used, and it is preferable in many cases for these to be fractions and non integer multiples of the size of the pits, bumps, facets, icons, etc.

In an embodiment different laser footprints can be used even if they are the same wavelength. For example one might be a circular footprint, and others more elliptical or any shape to shine on more features on the storage device without undesirably spilling over onto other tracks. Also the lasers can shine through various diffraction gratings and the reflection of these is read. Even one photon can create an interference pattern from one laser for example which can be shone on the pits and bumps.

Of course this can also be applied to any kind of CD like surface, as many techniques are being explored in the art. In the case of a variable depth on the surface this would give changes in the diffraction patterns reflected back which would give additional information about the surface.

In an embodiment a beam can also be shone on the surface and the reflection is interfered with a reference beam, the pattern from this giving information about the information on the storage surface. Of course this can equally be used to examine features on any surface as can all of these embodiments referred to in conjunction with storage devices for example only. Clearly these can also apply to microscopes and other detection means.

In the same way we could use multiple lasers like this to alter and write on the surface in ways a single laser could not, which translates into more memory storage.

According to another invention there is a means to analyse sounds.

It is an objective of this invention to separate sounds such as crowd noise so one can distinguish individual sounds clearly.

Preferably there are a plurality of recording means such as microphones at varying positions so as to triangulate sound input locations and feeding information to an analysing means.

Preferably this analysing means can take the sounds from each microphone and compare them.

Preferably this comparison can show the times common sounds happen in each recording on the assumption that sound takes time to travel so a microphone closer to a sound source will pick a given sound up before the others.

In the preferred embodiment there is a plurality of microphones set in a room with many sound sources so the microphones are in a position to triangulate the locations of each sound's position.

Preferably for this example only these sounds are people talking but they can be any sound sources.

Each microphone records the same sounds but the sounds will be slightly earlier in some microphones if they are closer to the sound source.

By analysing these differences and by other means of determining where the sound sources actually are the analysing means calculates which sound comes from which area and filters the others out.

Preferably this results in each sound being able to be heard in isolation from the others or in varying levels.

Example applications include listening in on sound sources without having a microphone with them, such as in eavesdropping but also in live music and speech recordings. Of course this system can be used anywhere signals with a delay need to be separated and analysed.

According to another invention there is provided a means to affect trajectories and movements of icons through a medium. Preferably these icons are in the form of fireworks and similar devices. Preferably the affecting means is by attaching these icons to each other or to other controlling devices.

According to a preferred embodiment fireworks are a popular form of entertainment in our society. They do have the limitation of being poorly controlled, so we usually see them in only vague patterns. In this invention the idea is to create different shapes, patterns and movements by manipulating them.

Such manipulation can take many forms. One preferred aspect is by connecting a plurality of firework and related icons to one another, such as by using a rigid, elastic or inelastic cable. Preferably this cable would be attached to the various icons before the assembly is released, though they may combine later.

Preferably when desirable the assembly of icons would move apart, by the operation of springs, rockets, explosions, even centripetal force from its spinning. Preferably all ways of disassembling the icon group can be used.

As the icons move apart they can be caused to initiate other actions such as exploding, setting off rockets, being a catalyst for other actions, and so on. In one preferred mode of operation when the strings become taut they can initiate the ignition of the various fireworks, similar to those we commonly see in fireworks displays.

The lengths of the strings can be tailored to give various desirable shapes in 2 and 3 D, such as animals, people, and geometric patterns. In one preferred embodiment there may be a shape of a dragon in 3D with exploding fireworks. One could imagine this as various lengths of string common from at least one assembly of icons that was spinning when launched. Icons could also be connected to one another by string, and there can also be string connections to other strings so the whole assembly is stable in shape.

According to another invention there is provided an addition to the concept of multi level marketing.

As is known in this art networks are constructed in which agents receive differing percentages for their commercial activities, resembling the branches of a tree.

One defect in this structure is that the products are often not very good, and do not compete well with other commercially available products such as those available in supermarkets.

It is an object of this invention to correct this problem by making the structure able to receive new products more easily, from the parent body and other sources.

Essentially this can preferably be represented by the roots of a tree connecting to the branches which represent a desirably constructed multi level marketing enterprise.

Preferably the set of roots connect by a common trunk to the branches though this can also be done in any known permutation of how roots and branches join. For example one root structure may supply separate branch structures.

In a preferred embodiment there is an established multi level branch system which needs new products.

In the structure there are envisaged inducements for interested parties to supply new products to the branches at competitive rates. They may sign up in distribution systems for the branches in ways where they receive commissions and discounts according to their positions in the root structure much as people do in the branch structures of multi level systems.

Preferably the product is initially introduced to the branch structure to one or more members who receive a preferred standard commission structure as profit they would receive and a recommended price list for various levels in the organization.

Preferably these initial members would contact other people in the branch structure who would receive a commission according to desirable criteria such as the volumes of product they sell through the people in their branch organization.

Preferably these branch and root structures are often in the form of Fibonacci branching with commissions substantially in the numerical ratios of Fibonacci numbers and the golden mean.

Just as in plants different people would tend to specialize at levels in the branch or root structures acting as forms of retailers and wholesalers.

It would be in the interest of some for example to supply perhaps one or two products and store them efficiently as a wholesaler tends to do, and deliver them to other parts of the structure much as wholesalers supply stores. He may elect to attempt to make lower offers on product as he is able to sell more, which goes through the root structure to where the actual supplier which may be the manufacturer agrees to lower his prices.

Preferably the commissions paid to each person in the structure don't change but the prices in this case would.

Other parts may elect to carry many products which may alter their ability to buy cheaper, though they can supply other parts of the branches and roots with a more varied choice.

The structure then would resemble a complete enterprise that looked for products to supply through its members at the best price, developed its own warehousing and distributions means, and this would flow into more standard multi level marketing allowing their products to be more competitive and successful.

There are many possibly separate inventions and applications. The scope of these separately and in combination is best left to the claims herein and in future alteration of claims. Also divisional applications may define this scope with different claims.

1. A scooping means to collect gases and materials from the atmosphere and to compress them into liquids and solids.

2. A device as claimed in claim 1 where the scooping means is a space craft and the gases and other materials are in the upper parts of the atmosphere.

3. A device as claimed in claim 1 where the materials are processed into solid slabs for construction, or are broken down to be reprocessed into other chemical structures.

4. A processing means as claimed in claim 3 which can be on a separate platform from the scooping means to process the materials into products such as hydrocarbons, rocket fuel, and plastics.

5. A scooping, compressing and processing means as claimed in claim 1 on the Earth's surface to produce hydrocarbons and other chemical compounds partially or wholly from these gases.
